(19) United States
(12) Patent Application Publication
(10) Pub. No.: US 2014/0205038 A1
(43) Pub. Date: Jul. 24, 2014

(54) TERMINAL DEVICE, BASE STATION DEVICE, PROGRAM, AND INTEGRATED CIRCUIT

(71) Applicants: Osamu Nakamura, Osaka-shi (JP); Jungo Goto, Osaka-shi (JP); Kazunari Yokomakura, Osaka-shi (JP); Yasuhiro Hamaguchi, Osaka-shi (JP)

(72) Inventors: Osamu Nakamura, Osaka-shi (JP); Jungo Goto, Osaka-shi (JP); Kazunari Yokomakura, Osaka-shi (JP); Yasuhiro Hamaguchi, Osaka-shi (JP)

(73) Assignee: SHARP KABUSHIKI KAISHA, Osaka-shi, Osaka (JP)

(21) Appl. No.: 14/236,990

(22) PCT Filed: Jul. 26, 2012
(86) PCT No.: PCT/JP2012/068958

§ 371 Date: Feb. 4, 2014

(30) Foreign Application Priority Data
Aug. 10, 2011 (JP) 2011-174473

(51) Int. Cl. H04B 7/04

(52) U.S. Cl. CPC H04B 7/0482
USPC 375/267

(57) ABSTRACT

In a cellular system, new precoding that enables the performance of precoding to be adequately utilized is introduced, and thereby throughput is increased. There is provided a terminal device that includes a plurality of transmit antennas and that performs precoding on a transmit signal. The terminal device includes a codebook selector 251 configured to select any one of a plurality of codebooks each including a plurality of precoding matrices, in accordance with the number of the transmit antennas and a transmission parameter other than the number of the transmit antennas, and a precoding matrix selector 255 configured to select any one precoding matrix from the selected codebook, in accordance with a PMI (Precoding Matrix Indicator).

### TECHNICAL FIELD

The present invention relates to a technology of transmitting a precoded signal by using a plurality of transmit antennas.

### BACKGROUND ART

In LTE (Long Term Evolution) release 8 (Rel-8), which is a wireless communication system standardized by 3GPP (3rd Generation Partnership Project), high-speed communication at 100 Mbps or more can be performed by using a frequency band of 20 MHz at a maximum. As a transmission scheme in the downlink (communication from a base station device to a terminal device) of LTE Rel-8, OFDM (Orthogonal Frequency Division Multiplexing) has been adopted, for the reasons of high resistance against frequency selective fading, high affinity with MIMO (Multiple Input Multiple Output) transmission, and so forth.

In the downlink of LTE Rel-8, MIMO transmission using up to four antenna ports can be performed (in the case of transmitting the same signal from a plurality of transmit antennas, these antennas are collectively defined as an antenna port). To increase the signal demultiplexing performance in a receiver, closed-loop MIMO is adopted, in which transmission is performed by multiplying an appropriate precoding matrix by a transmit signal in accordance with an instantaneous channel. An appropriate precoding matrix in the downlink can be grasped only by a terminal device (also referred to as a mobile terminal device, a mobile station device, or a terminal) as a receiver, and thus it is necessary for the terminal device to notify a base station device (also referred to as a control station device) of the appropriate precoding matrix. Here, to reduce the amount of information provided from the terminal device to the base station device, a precoding matrix based on a codebook is used in LTE. The terminal device selects an optimal precoding matrix from among precoding matrices included in a codebook, and notifies the base station device of the index thereof (PMI, Precoding Matrix Indicator).

On the other hand, in the uplink (communication from a terminal device to a base station device), the cost and scale of the terminal device are important. OFDM, in which a PAPR (Peak to Average Power Ratio) or a CM (Cubic Metric, an indicator indicating the degree of peak power represented by standard deviation of peak power with respect to average power of a signal waveform, like PAPR) is high, in which a power amplifier having a wide linear region is necessary, and in which power consumption is large, is not suitable for uplink transmission. Thus, in the uplink of LTE Rel-8, SC-FDMA (Single Carrier Frequency Division Multiple Access), in which a CM is low, is adopted.

In 3GPP, the standards of LTE Rel-10 and beyond are called LTE-A (LTE-Advanced), and the standardization thereof is in progress. MIMO transmission has not been specified in the uplink of LTE Rel-8, but it has been specified in Rel-10, and SU-MIMO (Single User MIMO) transmission using up to four antenna ports can be performed. In a case where four antenna ports are used, different pieces of data are transmitted from the individual antenna ports, and thereby transmission with the number of layers (also referred to as rank or the number of streams) 4 can be performed. Precoding based on a codebook is performed before transmission. A base station device selects, from a codebook, a precoding matrix with which the optimal transmission performances can be obtained, and notifies a terminal device of the selected precoding matrix. Here, different codebooks are provided in accordance with the number of antenna ports to be used. For example, in Rel-10, codebooks for the cases where the number of antenna ports to be used is one, two, and four are provided.

In the downlink of LTE Rel-8 in which the number of antenna ports is four, a House Holder (HH) matrix is adopted as a precoding matrix. On the other hand, in the uplink of Rel-10, a CMP (CM Preserving)-type precoding matrix is adopted. This is because, in the case of precoding using an HH matrix, a CM (PAPR) increases because a signal generated by adding a plurality of signals (layers) is transmitted from individual transmit antenna ports, whereas, in the case of precoding using a CMP-type matrix, a CM in the original state can be maintained because only one signal (layer) is transmitted from the individual antenna ports. However, in the CMP-type precoding, there is a restriction of maintaining a CM, and thus the transmission performances to be obtained by using an HH matrix are not expected. 3GPP has suggested a codebook that allows CMP-type precoding and CMF (CM Friendly)-type precoding, in which a CM is not maintained, to coexist in the same codebook regarding rank 3 transmission, as disclosed in NPL 2, but the codebook has not been adopted.

Also, in the specifications of RAN (Radio Access Network) 1 of LTE-10, Clustered DFT-S-OFDM (Discrete Fourier Transform Spread OFDM) is adopted in addition to MIMO transmission. In SC-FDMA, a single carrier spectrum is contiguously allocated to an arbitrary frequency band. On the other hand, in Clustered DFT-S-OFDM, a spectrum of SC-FDMA can be divided into two pieces, which can be noncontiguously allocated to an arbitrary frequency band.

### CITATION LIST

### Non Patent Literature

NPL 1: 3GPP TS36.211 V10.1.0
NPL 2: R1-100655, “Uplink Rank-3 Codebook Design for LTE-Advanced”, LGE

### SUMMARY OF INVENTION

### Technical Problem

In LTE-10, high priority is placed on not increasing a CM, and precoding using a CMP-type matrix is adopted. However, it is for a terminal device at the edge of a cell that a CM is important. A terminal device for which a CM is not important, such as a terminal device at the center of a cell, does not adequately utilize the original performance of the precoding technology.

The present invention has been made in view of these circumstances, and an object of the present invention is to provide a terminal device, a base station device, a program, and an integrated circuit that are capable of increasing throughput by introducing new precoding in which the performance of precoding can be adequately utilized in a cellular system.

### Solution to Problem

(1) To achieve the above-described object, the present invention provides the following means. That is, a terminal device according to the present invention is a terminal device that includes a plurality of transmit antennas and that performs precoding on a transmit signal. The terminal device includes a codebook selector configured to select any one of a plurality of codebooks each including a plurality of precoding matrices, in accordance with the number of the transmit antennas and a transmission parameter other than the number of the transmit antennas, and a precoding matrix selector configured to select any one precoding matrix from the selected codebook, in accordance with a PMI (Precoding Matrix Indicator).

In this way, any one of a plurality of codebooks each including a plurality of precoding matrices is selected in accordance with the number of the transmit antennas and a transmission parameter other than the number of the transmit antennas, and any one precoding matrix is selected from the selected codebook in accordance with a PMI (Precoding Matrix Indicator). Thus, even if the PMI is the same, different precoding operations can be performed in accordance with a transmission parameter other than the number of transmit antennas. As a result, precoding suitable for a transmission parameter other than the number of transmit antennas can be performed, and throughput can be increased with the coverage being maintained, compared to a case where the same precoding is constantly used. Also, a codebook is selected depending on a transmission parameter other than the selected number of transmit antennas, and thus it is not necessary to add information indicating which codebook is to be selected. Therefore, an increase in the amount of downlink control information can be prevented.

(2) Further, in the terminal device according to the present invention, the transmission parameter is a magnitude of a CM (Cubic Metric) of a transmit signal.

The transmission parameter is a magnitude of a CM (Cubic Metric), and thus precoding suitable for the magnitude of a CM can be performed. Thus, throughput can be increased with the coverage being maintained, compared to a case where the same precoding is constantly used.

(3) Further, in the terminal device according to the present invention, the transmission parameter is information representing a transmission scheme.

The transmission parameter is information representing a transmission scheme, and thus precoding suitable for the transmission scheme can be performed. Thus, throughput can be increased with the coverage being maintained, compared to a case where the same precoding is constantly used.

(4) Further, in the terminal device according to the present invention, the transmission parameter is information representing an allocation pattern of a spectrum.

The transmission parameter is information representing an allocation pattern of a spectrum. Thus, the transmission performances of the terminal device for which degradation of a CM is not importance can be improved with the coverage being maintained, compared to the case of using a codebook constituted by only precoding matrices that maintain a CM. As a result, cell throughput can be increased.

(5) Further, in the terminal device according to the present invention, the transmission parameter is information representing a modulation scheme.

The transmission parameter is information representing a modulation scheme. Thus, for example, in fractional TPC in which transmit power control (TPC) is performed so that the power for reception increases as a terminal device becomes closer to the center of a cell, a signal of a terminal device at the edge of a cell is received with low power, and thus a low-order modulation scheme is used for transmission. In this case, precoding can be performed with the CM being maintained, and the transmission performances are not degraded. On the other hand, a signal of a terminal device at the center of a cell is received with high power, and thus a high-order modulation scheme is used. In this case, a precoding matrix for increasing a transmit antenna diversity gain is selected. Thus, compared to the case of performing precoding with a CM being maintained on all terminal devices, the transmission performances can be improved.

(6) Further, in the terminal device according to the present invention, the codebook selector selects any one of a codebook including a plurality of precoding matrices that maintain a CM (Cubic Metric) of a transmit signal, and a codebook including a plurality of precoding matrices that enable acquisition of a favorable transmit antenna gain.

In this way, any one of a codebook including a plurality of precoding matrices that maintain a CM (Cubic Metric) of a transmit signal, and a codebook including a plurality of precoding matrices that enable acquisition of a favorable transmit antenna gain is selected. Thus, even if the PMI is the same, different precoding operations can be performed in accordance with a transmission parameter other than the number of transmit antennas. As a result, precoding suitable for a transmission parameter other than the number of transmit antennas can be performed, and throughput can be increased with the coverage being maintained, compared to a case where the same precoding is constantly used. Also, a codebook is selected depending on a transmission parameter other than the selected number of transmit antennas, and thus it is not necessary to add information indicating which codebook is to be selected. Therefore, an increase in the amount of downlink control information can be prevented.

(7) A base station device according to the present invention is a base station device that performs wireless communication with a terminal device that transmits a precoded signal by using a plurality of transmit antennas. The base station device includes a codebook selector configured to select any one of a plurality of codebooks each including a plurality of precoding matrices, in accordance with the number of the transmit antennas of the terminal device and a transmission parameter other than the number of the transmit antennas, and an index selector configured to select any one precoding matrix from the selected codebook and select an index representing the selected precoding matrix. Information representing the selected index is transmitted to the terminal device.

In this way, any one of a plurality of codebooks each including a plurality of precoding matrices is selected in accordance with the number of the transmit antennas and a transmission parameter other than the number of the transmit antennas, and any one precoding matrix is selected from the selected codebook in accordance with a PMI (Precoding Matrix Indicator). Thus, even if the PMI is the same, different precoding operations can be performed in accordance with a transmission parameter other than the number of transmit antennas. As a result, precoding suitable for a transmission parameter other than the number of transmit antennas can be performed, and throughput can be increased with the coverage being maintained, compared to a case where the same precoding is constantly used. Also, a codebook is selected depending on a transmission parameter other than the selected number of transmit antennas, and thus it is not necessary to add information indicating which codebook is to be selected. Therefore, an increase in the amount of downlink control information can be prevented.

(8) A program according to the present invention is a program for controlling a terminal device that includes a plurality of transmit antennas and that performs precoding on a transmit signal. The program causes a computer to execute a series of processes including a process of selecting any one of a plurality of codebooks each including a plurality of precoding matrices, in accordance with the number of the transmit antennas and a transmission parameter other than the number of the transmit antennas, and a process of selecting any one precoding matrix from the selected codebook, in accordance with a PMI (Precoding Matrix Indicator).

In this way, any one of a plurality of codebooks each including a plurality of precoding matrices is selected in accordance with the number of the transmit antennas and a transmission parameter other than the number of the transmit antennas, and any one precoding matrix is selected from the selected codebook in accordance with a PMI (Precoding Matrix Indicator). Thus, even if the PMI is the same, different precoding operations can be performed in accordance with a transmission parameter other than the number of transmit antennas. As a result, precoding suitable for a transmission parameter other than the number of transmit antennas can be performed, and throughput can be increased with the coverage being maintained, compared to a case where the same precoding is constantly used. Also, a codebook is selected depending on a transmission parameter other than the selected number of transmit antennas, and thus it is not necessary to add information indicating which codebook is to be selected. Therefore, an increase in the amount of downlink control information can be prevented.

(9) An integrated circuit according to the present invention is an integrated circuit that, by being mounted in a terminal device including a plurality of transmit antennas, causes the terminal device to exhibit a plurality of functions. The integrated circuit causes the terminal device to exhibit a series of functions including a function of selecting any one of a plurality of codebooks each including a plurality of precoding matrices, in accordance with the number of the transmit antennas and a transmission parameter other than the number of the transmit antennas, a function of selecting any one precoding matrix from the selected codebook, in accordance with a PMI (Precoding Matrix Indicator), and a function of performing precoding on a transmit signal by using the selected precoding matrix.

In this way, any one of a plurality of codebooks each including a plurality of precoding matrices is selected in accordance with the number of the transmit antennas and a transmission parameter other than the number of the transmit antennas, and any one precoding matrix is selected from the selected codebook in accordance with a PMI (Precoding Matrix Indicator). Thus, even if the PMI is the same, different precoding operations can be performed in accordance with a transmission parameter other than the number of transmit antennas. As a result, precoding suitable for a transmission parameter other than the number of transmit antennas can be performed, and throughput can be increased with the coverage being maintained, compared to a case where the same precoding is constantly used. Also, a codebook is selected depending on a transmission parameter other than the selected number of transmit antennas, and thus it is not necessary to add information indicating which codebook is to be selected. Therefore, an increase in the amount of downlink control information can be prevented.

### Advantageous Effects of Invention

According to the present invention, a terminal device is capable of increasing throughput with the coverage being maintained.

### BRIEF DESCRIPTION OF DRAWINGS

FIG. 1 is s schematic block diagram illustrating the configuration of a wireless communication system according to a first embodiment of the present invention.

FIG. 2 is a schematic block diagram illustrating the configuration of a terminal device 1-2 according to the first embodiment of the present invention.

FIG. 3 is a block diagram illustrating the configuration of each of OFDM signal generators 119-1 to 119-Nt according to the first embodiment of the present invention.

FIG. 4 is a schematic block diagram illustrating the configuration of a precoding matrix determination unit 133 according to the first embodiment of the present invention.

FIG. 5 is a diagram illustrating an example of a codebook according to the present invention.

FIG. 6 is a diagram illustrating an example of a codebook according to the present invention.

FIG. 7 is a flowchart illustrating processing performed within the precoding matrix determination unit 133 illustrated in FIG. 4 according to the first embodiment of the present invention.

FIG. 8 is a schematic block diagram illustrating the configuration of a base station device 3 according to the first embodiment of the present invention.

FIG. 9 is a schematic block diagram illustrating the configuration of an OFDM signal receiver 305 according to the first embodiment of the present invention.

FIG. 10 is a schematic block diagram illustrating the configuration of a PMI determination unit 329 according to the first embodiment of the present invention.

FIG. 11 is a flowchart illustrating processing performed within the PMI determination unit 329 illustrated in FIG. 10 according to the first embodiment of the present invention.

FIG. 12 is a sequence chart illustrating processing performed by the terminal device 1-2 and the base station device 3 according to the first embodiment of the present invention.

FIG. 13 is a schematic block diagram illustrating the communication device configuration of a terminal device 1 according to a second embodiment of the present invention.

FIG. 14 is a schematic block diagram illustrating the configuration of a precoding matrix determination unit 601 according to the second embodiment of the present invention.

FIG. 15 is a flowchart illustrating processing performed within the precoding matrix determination unit 601 illustrated in FIG. 14 according to the second embodiment of the present invention.

FIG. 16 is a schematic block diagram illustrating the receiver configuration of a base station device 3 according to the second embodiment of the present invention.

FIG. 17 is a schematic block diagram illustrating the configuration of a PMI determination unit 701 according to the second embodiment of the present invention.

FIG. 18 is a flowchart illustrating processing performed within the PMI determination unit 701 illustrated in FIG. 17 according to the second embodiment of the present invention.

FIG. 19 is a sequence chart illustrating processing performed by the terminal device 1 and the base station device 3 according to the second embodiment of the present invention.

FIG. 20A is a schematic diagram of a system band in which clusters are arranged.

FIG. 20B is a schematic diagram of a system band in which clusters are arranged.

FIG. 21A is a schematic diagram of a system band in which clusters are arranged.

FIG. 21B is a schematic diagram of a system band in which clusters are arranged.

FIG. 22 is a schematic block diagram illustrating the transmitter configuration of a terminal device 1 according to a third embodiment of the present invention.

FIG. 23 is a schematic block diagram illustrating the configuration of a precoding matrix determination unit 901 according to the third embodiment of the present invention.

FIG. 24 is a flowchart illustrating processing performed within the precoding matrix determination unit 901 illustrated in FIG. 23 according to the third embodiment of the present invention.

FIG. 25 is a schematic block diagram illustrating the receiver configuration of a base station device 3 according to the third embodiment of the present invention.

FIG. 26 is a schematic block diagram illustrating the configuration of a PMI determination unit 1101 according to the third embodiment of the present invention.

FIG. 27 is a flowchart illustrating processing performed within the PMI determination unit 1101 illustrated in FIG. 26 according to the third embodiment of the present invention.

FIG. 28 is a sequence chart illustrating processing performed by the terminal device 1 and the base station device 3 according to the third embodiment of the present invention.

### DESCRIPTION OF EMBODIMENTS

Hereinafter, embodiments of the present invention will be described with reference to the drawings.

### First Embodiment

In a first embodiment of the present invention, a codebook is changed in accordance with whether or not a transmission scheme is OFDM. Hereinafter, the first embodiment of the present invention will be described. In this embodiment, a precoding technology different from Rel-10 is applied to only OFDM in a case where OFDM is newly adopted in addition to SC-FDMA and Clustered DFT-S-OFDM that are adopted in the uplink of LTE Rel-10.

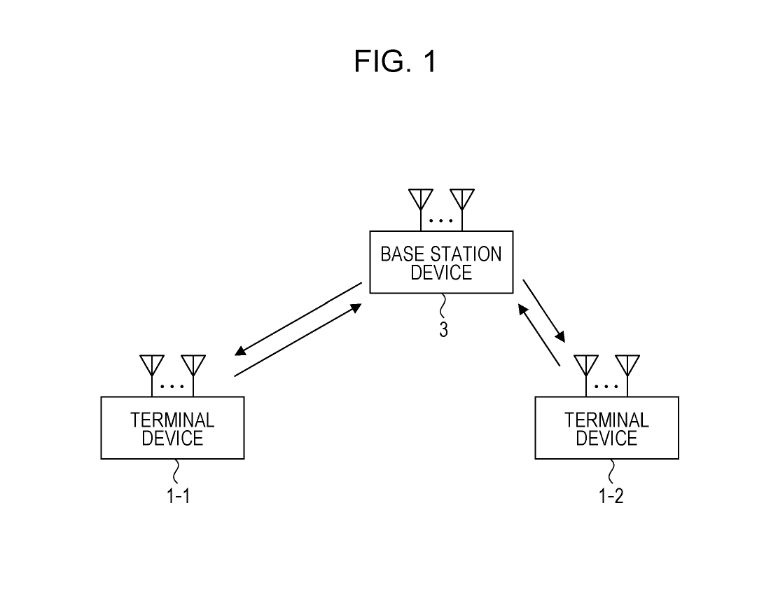

FIG. 1 is a schematic block diagram illustrating the configuration of a wireless communication system according to the first embodiment of the present invention. The wireless communication system includes terminal devices 1-1 and 1-2, and a base station device 3. The terminal device 1-1 is a terminal device of Rel-10 that wirelessly communicates with the base station device 3, and uses SC-FDMA or Clustered DFT-S-OFDM as a transmission scheme for transmission. At this time, the terminal device 1-1 performs CMP-type precoding in which a CM is not increased. On the other hand, the terminal device 1-2 is a terminal device of Ref-10 or beyond that wirelessly communicates with the base station device 3, like the terminal device 1-1, and is capable of using OFDM in addition to SC-FDMA and Clustered DFT-S-OFDM as a transmission scheme for transmission. FIG. 1 illustrates a single terminal device 1-1 and a single terminal device 1-2, but there may be a plurality of terminal devices 1-1 and a plurality of terminal devices 1-2. The terminal devices 1-1 and 1-2 are also collectively referred to as terminal devices 1. Hereinafter, transmission processing performed by the terminal device 1-2 will be described with reference to the drawings.

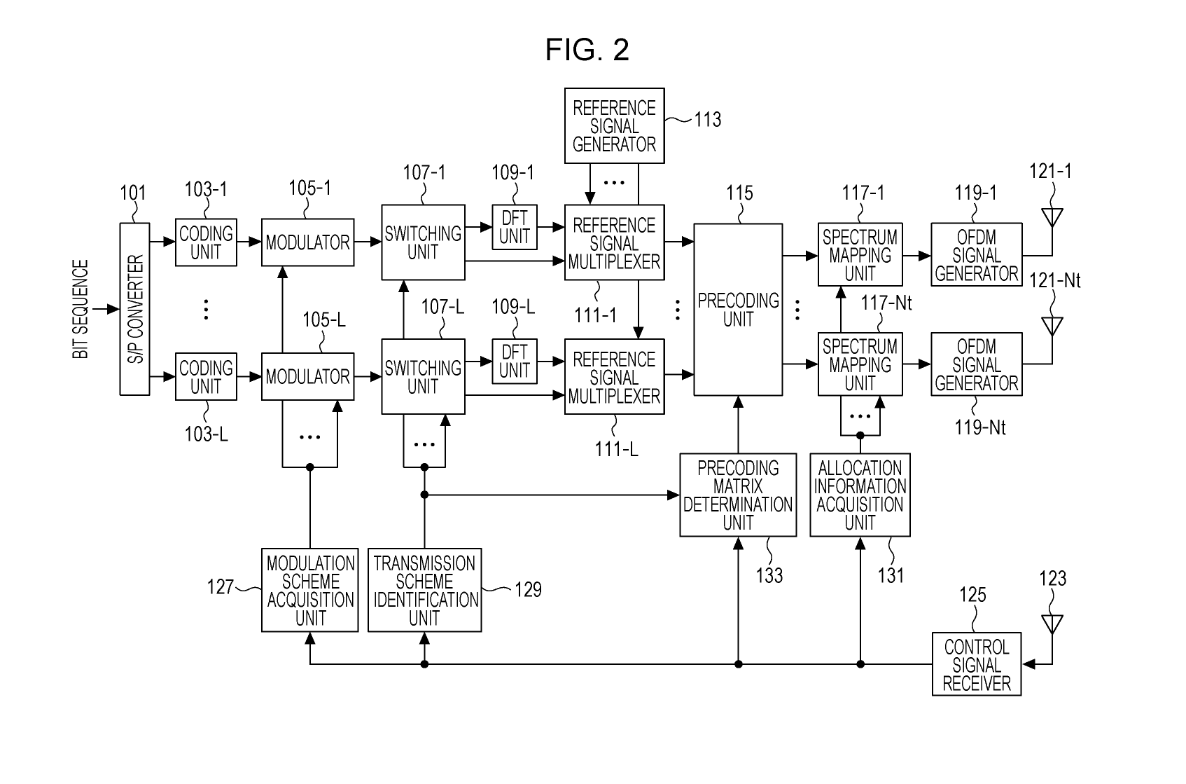

FIG. 2 is a schematic block diagram illustrating the configuration of the terminal device 1-2 according to the first embodiment of the present invention. The terminal device 1-2 includes an S/P (Serial/Parallel) converter 101, coding units 103-1 to 103-L (hereinafter the coding units 103-1 to 103-L are also collectively referred to as coding units 103), modulators 105-1 to 105-L (hereinafter the modulators 105-1 to 105-L are also collectively referred to as modulators 105), switching units 107-1 to 107-L (hereinafter the switching units 107-1 to 107-L are also collectively referred to as switching units 107), DFT (Discrete Fourier Transform) units 109-1 to 109-L (hereinafter the DFT units 109-1 to 109-L are also collectively referred to as DFT units 109), reference signal multiplexers 111-1 to 111-L (hereinafter the reference signal multiplexers 111-1 to 111-L are also collectively referred to as reference signal multiplexers 111), a reference signal generator 113, a precoding unit 115, spectrum mapping units 117-1 to 117-Nt, OFDM (Orthogonal Frequency Division Multiplex) signal generators 119-1 to 119-Nt (hereinafter the OFDM signal generators 119-1 to 119-Nt are also collectively referred to as OFDM signal generators 119), transmit antennas 121-1 to 121-Nt (hereinafter the transmit antennas 121-1 to 121-Nt are also collectively referred to as transmit antennas 121), a receive antenna 123, a control signal receiver 125, a modulation scheme acquisition unit, a transmission scheme identification unit 129, an allocation information acquisition unit 131, and a precoding matrix determination unit 133.

A data bit sequence to be transmitted to the base station device 3 is input to the S/P converter 101, undergoes serial-to-parallel conversion so as to be output in parallel in accordance with the number of layers (rank or the number of streams), and results are respectively input to the coding units 103-1 to 103-L. Here, L represents the number of layers. In each of the coding units 103-1 to 103-L, error correction coding is applied. In FIG. 2, the number of the coding units 103 is L, but a bit sequence may be input to a coding unit 103 and may be input to the modulators 105-1 to 105-L of individual layers through S/P conversion. The outputs of the individual coding units 103-1 to 103-L are input to the modulators 105-1 to 105-L. The individual modulators 105-1 to 105-L convert the bit sequence input from the coding units 103-1 to 103-L to modulation symbols of QPSK (Quadrature Phase Shift Keying), 16QAM (Quadrature Amplitude Modulation), 64QAM, 256QAM, or the like, by using information representing a modulation scheme input from the modulation scheme acquisition unit 127. Here, the modulation schemes applied in the individual modulators 105-1 to 105-L may be the same, or may be different from one another in consideration of the reception quality in each layer. In FIG. 2, the number of coding units 103 is the same as the number of modulators 105. Alternatively, as in LTE-A, coded bits output from two coding units 103 may be input to a layer mapping unit and may be mapped to two to four modulators 105.

The modulators 105-1 to 105-L input modulation symbols to the switching units 107 in units of N_{DFT} symbols. The switching units 107 input the modulation symbols to the DFT units 109 or the reference signal multiplexers 111 in accordance with the information input from the transmission scheme identification unit 129. Note that, in a case where the information input from the transmission scheme identification unit 129 represents SC-FDMA or Clustered DFT-S-OFDM, the switching units 107 input the modulation symbols to the DFT units 109 and, in a case where the information represents OFDM, the switching units 107 input the modulation symbols to the reference signal multiplexers 111. In a case where the modulation symbols are input to the DFT units 109, the input modulation symbols undergo discrete Fourier transform (DFT) in units of N_{DFT} symbols, so that N_{DFT} time-domain signals are transformed to N_{DFT} frequency-domain signals. Each of the DFT units 109-1 to 109-L inputs N_{DFT} frequency-domain signals to a corresponding one of the reference signal multiplexers 111-1 to 111-L. Each of the reference signal multiplexers 111-1 to 111-L forms a transmission frame by using the N_{DFT} signals input from the corresponding DFT unit 109 or switching unit 107 and a demodulation reference signal (DMRS) input from the reference signal generator 113.

The outputs of the reference signal multiplexers 111-1 to 111-L are input to the precoding unit 115. The precoding unit 115 multiplies a precoding matrix of Nt rows and L columns by the signals input from the reference signal multiplexers 111 in accordance with the information provided from the precoding matrix determination unit 133. Here, Nt represents the number of transmit antennas. The precoding matrix determination unit 133 will be described below. The outputs of the precoding unit 115 are input to the spectrum mapping units 117-1 to 117-Nt. The spectrum mapping units 117-1 to 117-Nt map the outputs of the precoding unit 115 within a system band in accordance with the allocation information (scheduling information) input from the allocation information acquisition unit 131. Here, the spectrum mapping applied to the individual transmit antennas 121 may be the same as illustrated in FIG. 2, or may be independently performed for each antenna. The outputs of the spectrum mapping units 117-1 to 117-Nt are input to the corresponding OFDM signal generators 119-1 to 119-Nt.

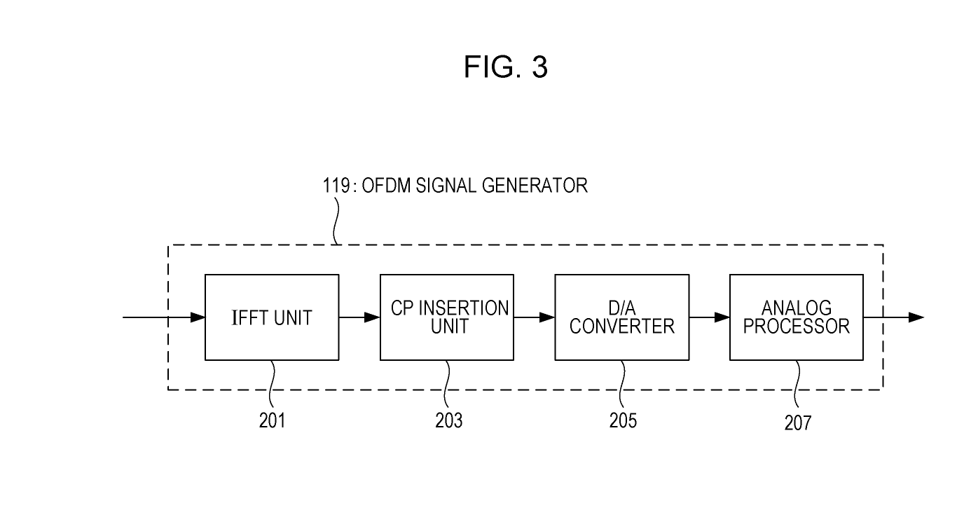

FIG. 3 is a block diagram illustrating the configuration of each of the OFDM signal generators 119-1 to 119-Nt according to the first embodiment of the present invention. The output of each of the spectrum mapping units 117-1 to 117-Nt undergoes inverse fast Fourier transform (IFFT) performed by an IFFT unit 201, and transform from a frequency-domain signal to a time-domain signal is performed. The output of the IFFT unit 201 is input to a CP insertion unit 203, in which cyclic prefix (CP) is inserted in units of SC-FDMA symbols. Furthermore, the SC-FDMA symbol to which CP has been inserted undergoes D/A (digital to analog) conversion in a D/A converter 205, and is then input to an analog processor 207. The analog processor 207 performs analog filtering, up-conversion to a carrier frequency, and so forth. The output of the analog processor 207 is transmitted from a corresponding one of the transmit antennas 121-1 to 121-Nt.

The control signal receiver 125 receives, via the receive antenna 123, a control information signal transmitted from the base station device 3 illustrated in FIG. 1, and inputs the obtained control information to the modulation scheme acquisition unit 127, the transmission scheme identification unit 129, the allocation information acquisition unit 131, and the precoding matrix determination unit 133.

The allocation information acquisition unit 131 extracts spectrum allocation information from the control information input from the control signal receiver 125, and inputs the spectrum allocation information to the individual spectrum mapping units 117-1 to 117-Nt. The modulation scheme acquisition unit 127 extracts information regarding a modulation scheme from the control information, and inputs the extracted information to the individual modulators 105-1 to 105-L. The transmission scheme identification unit 129 identifies the transmission scheme to be used in uplink, by using the control information input thereto. As an identification method, the base station device 3 may directly provide information representing a transmission scheme. Alternatively, information representing a transmission scheme is not directly provided, and the base station device 3 and the terminal device 1-2 may grasp a transmission scheme, for example, OFDM is used as a transmission scheme in a case where the modulation scheme is 64QAM. Alternatively, the terminal device 1-2 may identify a transmission scheme by using information about rank, carrier aggregation, or the like other than a modulation scheme. Information regarding a transmission scheme, which is output by the transmission scheme identification unit 129, is input to the switching units 107 and the precoding matrix determination unit 133.

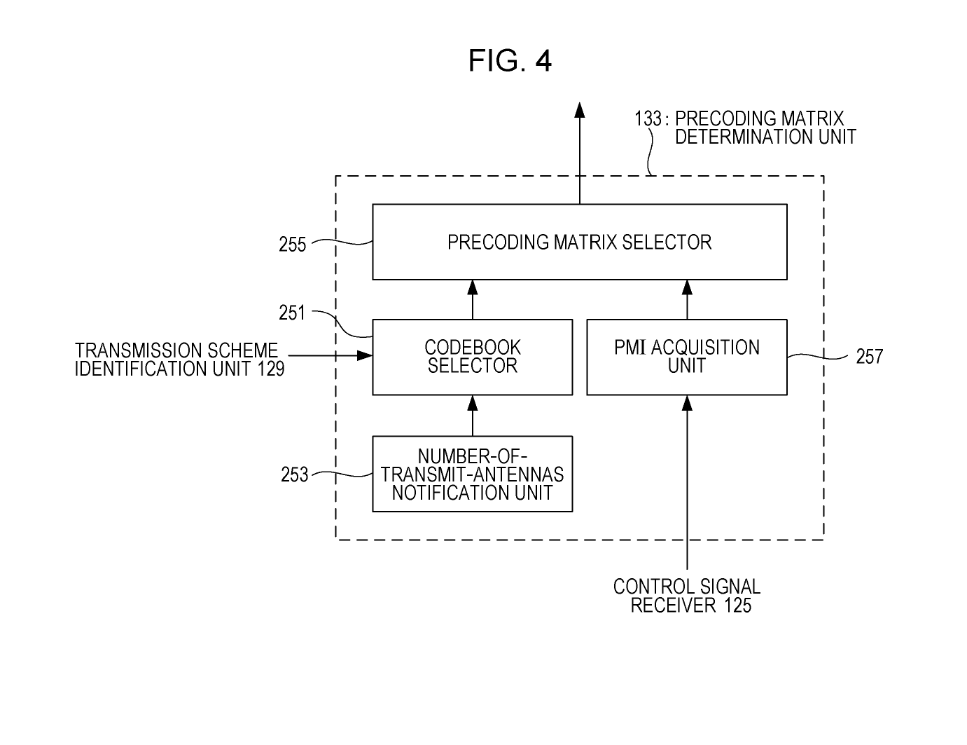

FIG. 4 is a schematic block diagram illustrating the configuration of the precoding matrix determination unit 133 according to the first embodiment of the present invention. A codebook selector 251 selects, from among a plurality of codebooks, a plurality of codebooks in accordance with the number of transmit antennas (the number of antenna ports) reported by a number-of-transmit-antennas notification unit 253, and further selects a certain codebook in accordance with the transmission scheme input from the transmission scheme identification unit 129. That is, a codebook is selected in accordance with the number of transmit antennas and a transmission scheme.

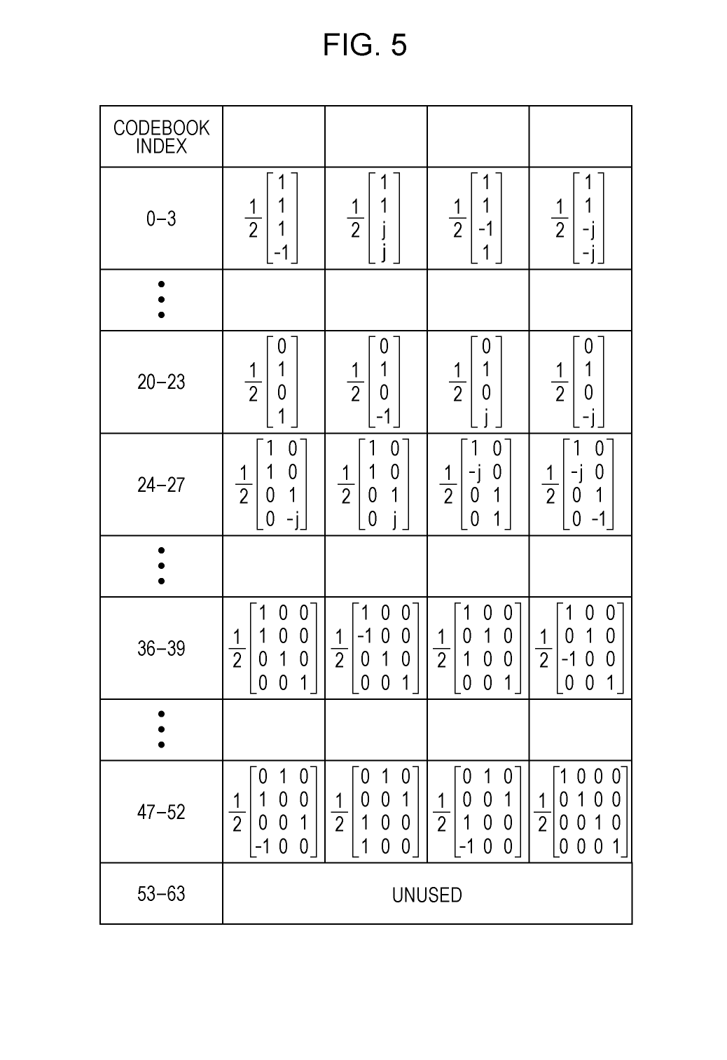

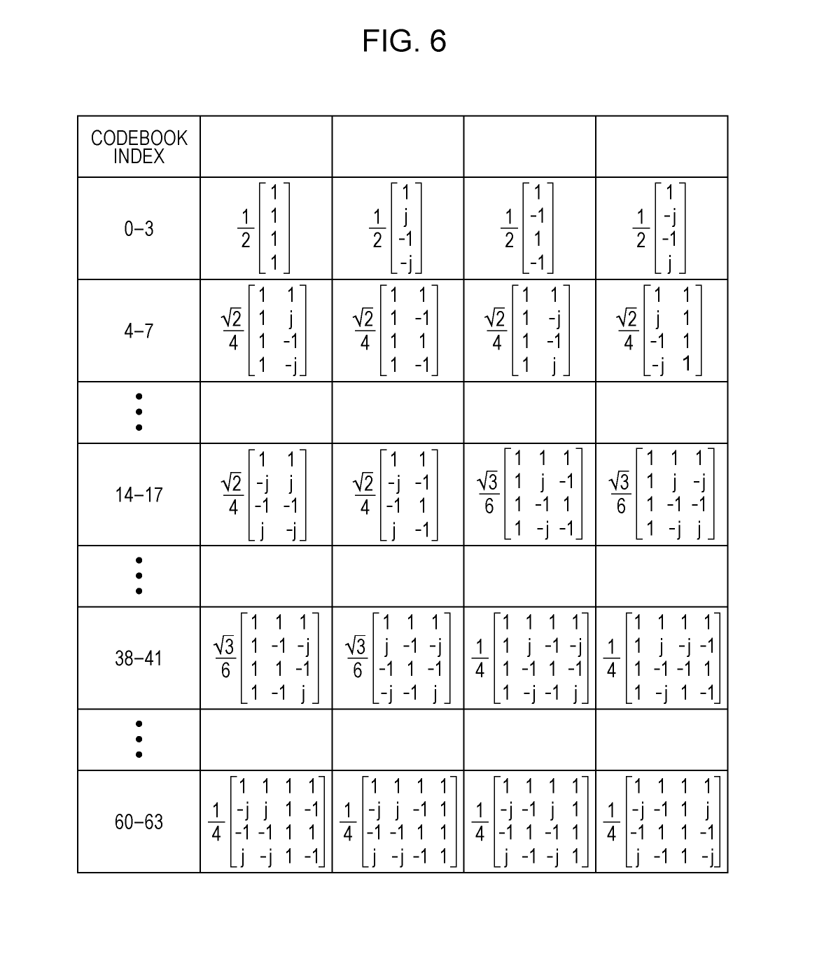

FIGS. 5 and 6 are diagrams illustrating examples of a codebook according to the present invention. For example, in a case where the number of transmit antennas of the terminal device 1 is four and where the transmission scheme is SC-FDMA (or Clustered DFT-S-OFDM), the codebook illustrated in FIG. 5 is used. On the other hand, in a case where the number of transmit antennas is four and where the transmission scheme is OFDM, the codebook illustrated in FIG. 6 is used. Here, the individual rows of each precoding matrix represent an index of the transmit antenna 121 (that is, four transmit antennas), and the individual columns represent rank (the number of streams of different transmit signals that are simultaneously transmitted). For example, in the case of FIG. 5, indexes 0 to 23 correspond to precoding matrices for rank 1, indexes 24 to 35 correspond to precoding matrices for rank 2, indexes 36 to 51 correspond to precoding matrices for rank 3, and index 52 corresponds to a precoding matrix for rank 4.

Here, regarding all the precoding matrices described in the codebook illustrated in FIG. 5, the number of values other than zero is one (or zero) in each row. This indicates that each transmit antenna transmits one signal (layer) or transmits nothing. That is, in each transmit antenna, signals are not added together, and thus the CM (PAPR) of a transmit signal is maintained. In a matrix in which there are a plurality of values other than zero in a single column, a certain signal (layer) is transmitted from a plurality of antennas, and thus transmit antenna diversity gain can be obtained in a receiver. Note that, because a single layer is transmitted from two antennas at a maximum, and thus transmit antenna diversity gain is limited.

On the other hand, in the codebook illustrated in FIG. 6, unlike in the codebook illustrated in FIG. 5, zero does not exist in each row. This indicates that each antenna adds a plurality of layers and transmits the layers. As a result, the CM (PAPR) of a transmit signal increases. However, since no zero exists also in each column, individual layers are transmitted from all antennas. As a result, favorable transmit antenna diversity gain can be obtained in the receiver.

The codebook selector 251 inputs the selected codebook to a precoding matrix selector 255. The control information input from the control signal receiver 125 is input to a PMI acquisition unit 257, and only a PMI is extracted. The extracted PMI is input to the precoding matrix selector 255.

The precoding matrix selector 255 selects a precoding matrix by using the codebook input from the codebook selector 251 and the index input from the PMI acquisition unit 257. For example, in a case where the codebook illustrated in FIG. 5 is input from the codebook selector 251 and “37” is input as an index from the PMI acquisition unit 257, the precoding matrix selector 255 selects

$$\begin{matrix}[ Math . 1 ] & \\ \frac{1}{2} [ \begin{matrix}1 & 0 & 0 \\ - 1 & 0 & 0 \\ 0 & 1 & 0 \\ 0 & 0 & 1\end{matrix} ] & ( 1 )\end{matrix}$$

and inputs it, as an output of the precoding matrix determination unit 133, to the precoding unit 115.

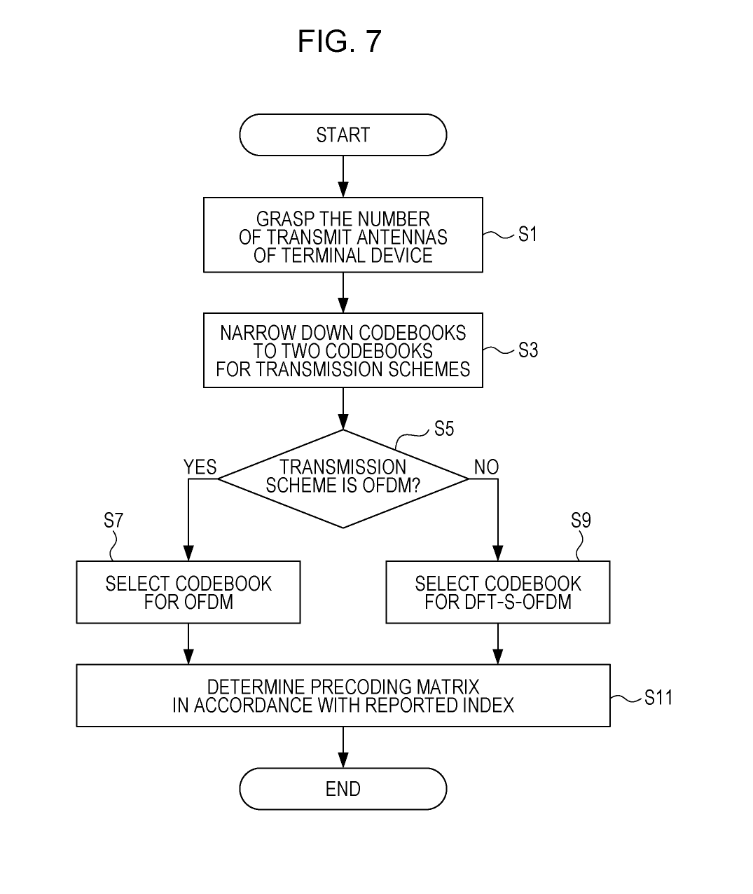

FIG. 7 is a flowchart illustrating processing performed within the precoding matrix determination unit 133 illustrated in FIG. 4, according to the first embodiment of the present invention. First, the terminal device 1-2 grasps the number of transmit antennas included in the terminal device 1-2 (step S1). Subsequently, the terminal device 1-2 limits the codebooks to be used, in accordance with the number of transmit antennas (step S3). At this stage, the codebooks are narrowed down to two codebooks for OFDM and DFT-S-OFDM. Subsequently, the terminal device 1-2 judges whether or not the transmission scheme that is reported from the base station device 3 and that is to be used in the next transmission is OFDM (step S5). In a case where the transmission scheme is OFDM (YES in step S5), the terminal device 1-2 selects the codebook for OFDM (step S7). In a case where the transmission scheme is not OFDM (NO in step S5), the terminal device 1-2 selects the codebook for DFT-S-OFDM (step S9). Finally, the terminal device 1-2 determines the precoding matrix to be used for the next transmission in accordance with the selected codebook and the PMI reported from the base station device 3 (step S11), and performs the next transmission by using the determined precoding matrix.

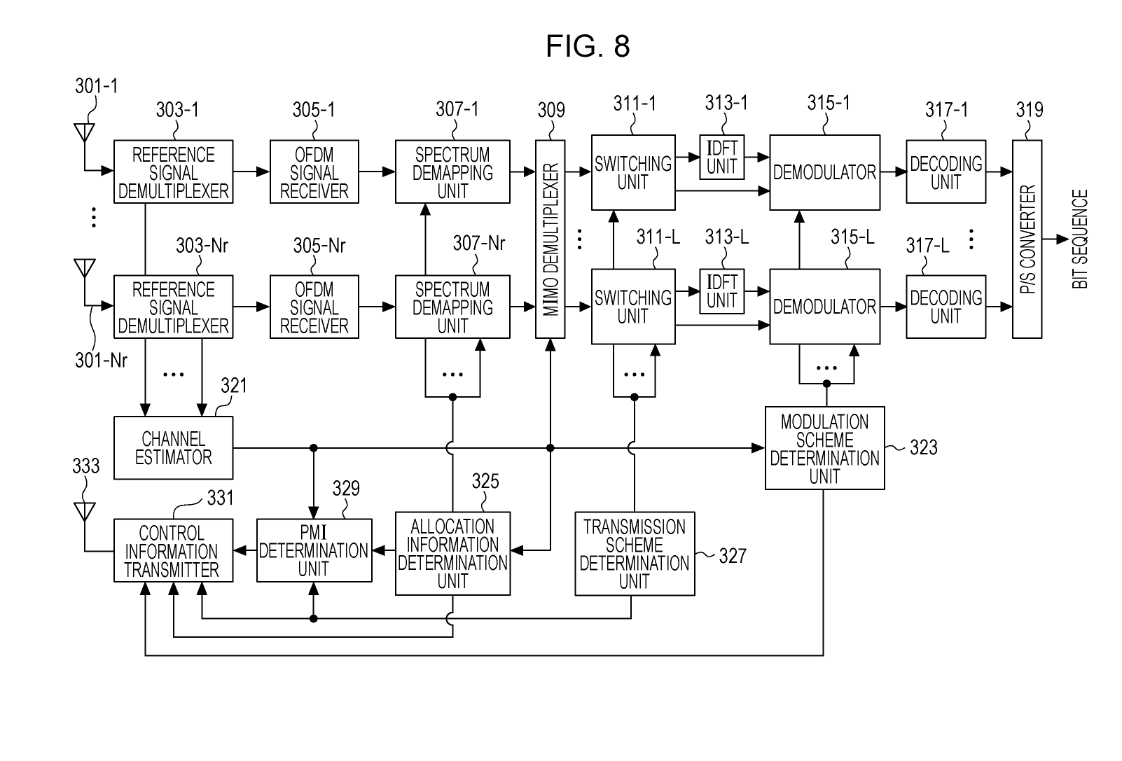

FIG. 8 is a schematic block diagram illustrating the configuration of the base station device 3 according to the first embodiment of the present invention. The base station device 3 includes receive antennas 301-1 to 301-Nr (hereinafter the receive antennas 301-1 to 301-Nr are also collectively referred to as receive antennas 301), reference signal demultiplexers 303-1 to 303-Nr (hereinafter the reference signal demultiplexers 303-1 to 303-Nr are also collectively referred to as reference signal demultiplexers 303), OFDM signal receivers 305-1 to 305-Nr (hereafter the OFDM signal receivers 305-1 to 305-Nr are also collectively referred to as OFDM signal receivers 305), spectrum demapping units 307-1 to 307-Nr, a MIMO demultiplexer 309, switching units 311-1 to 311-L (hereinafter the switching units 311-1 to 311-L are also collectively referred to as switching units 311), IDFT units 313-1 to 313-L (hereinafter the IDFT units 313-1 to 313-L are also collectively referred to as IDFT units 313), demodulators 315-1 to 315-L (hereinafter the demodulators 315-1 to 315-L are collectively referred to as demodulators 315), decoding units 317-1 to 317-L, a P/S converter 319, a channel estimator 321, a modulation scheme determination unit 323, an allocation information determination unit 325, a transmission scheme determination unit 327, a PMI determination unit 329, and a control information transmitter 331.

Signals transmitted from the terminal devices 1-1 and 1-2 are received by, via a wireless channel, the receive antennas 301-1 to 301-Nr of the base station device 3 illustrated in FIG. 8. The signals received by the receive antennas 301-1 to 301-Nr are input to the reference signal demultiplexers 303 connected to the respective receive antennas. Each of the reference signal demultiplexers 303 demultiplexes the received signal into a data signal and a reference signal, inputs the data signal to the corresponding OFDM signal receiver 305, and inputs the reference signal to the channel estimator 321. The channel estimator 321 estimates, using the reference signal input thereto, the channel between the transmit antenna 121 and the receive antenna 301. A channel estimation value obtained thereby is input to the MIMO demultiplexer 309, the allocation information determination unit 325, the PMI determination unit 329, and the modulation scheme determination unit 323.

The modulation scheme determination unit 323 determines the modulation scheme to be used for the next transmission by using the channel estimation value input thereto, and inputs the determined demodulation scheme to the control information transmitter 331. The determined demodulation scheme is stored in the demodulation scheme determination unit 323, and is input to the demodulators 315-1 to 315-L to demodulate signals transmitted from a terminal. The allocation information determination unit 325 determines, in accordance with the channel estimation value input thereto, information indicating which terminal device 1-2 uses which frequency for the next transmission (allocation information), and inputs the information to the PMI determination unit 329 and the control information transmitter 331. Also, the determined allocation information is stored in the allocation information determination unit 325, and is input to the spectrum demapping units 307-1 to 307-Nr to perform spectrum demapping on signals transmitted from the terminal.

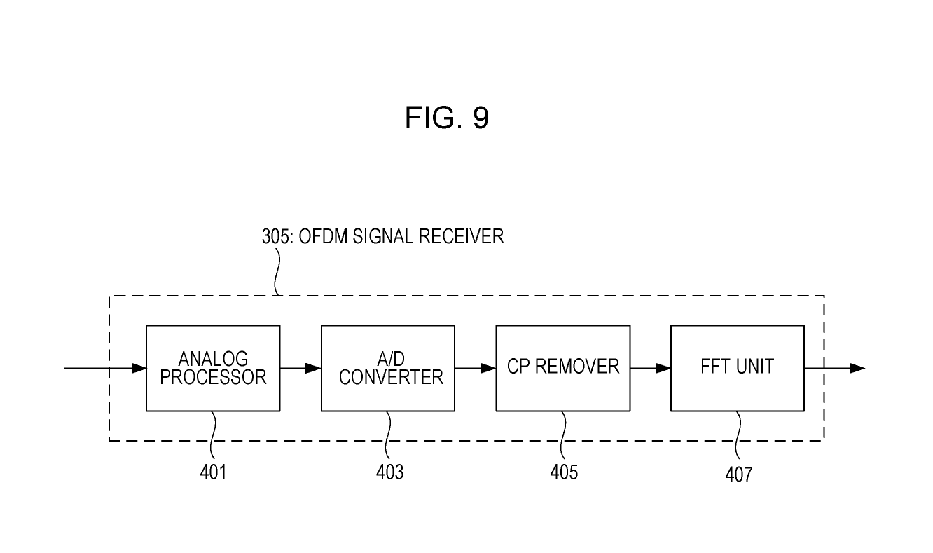

On the other hand, the received data signals are individually input from the reference signal demultiplexers 303 to the OFDM signal receivers 305-1 to 305-Nr. FIG. 9 is a schematic block diagram illustrating the configuration of each of the OFDM signal receivers 305 according to the first embodiment of the present invention. Each of the OFDM signal receivers 305-1 to 305-Nr inputs a signal input thereto to an analog processor 401, which performs down-conversion from a carrier frequency to a baseband, analog filtering, and so forth. The output of the analog processor 401 is input to an A/D converter 403, which performs A/D (analog to digital) conversion. After that, the CP added by the terminal devices 1-1 and 1-2 is removed by a CP remover 405, fast Fourier transform (FFT) is performed by an FFT unit 407, and a frequency-domain signal generated through the transform is output to a corresponding one of the spectrum demapping units 307-1 to 307-Nr illustrated in FIG. 8 that are individually connected.

The spectrum demapping units 307-1 to 307-Nr extract frequency-domain signals in the frequency bands that have been used for communication, on the basis of the allocation information input from the allocation information determination unit 325. The frequency-domain signals extracted by the individual spectrum demapping units 307-1 to 307-Nr are input to the MIMO demultiplexer 309.

The MIMO demultiplexer 309 demultiplexes a spatially multiplexed signal into L layers, by using the inputs from the spectrum demapping units 307-1 to 307-Nr and the input from the channel estimator 321. A demultiplexing method may be any method, such as spatial filtering (ZF (Zero Forcing), MMSE (Minimum Mean Square Error), etc.), SIC (Successive Interference Cancellation), V-BLAST (Vertical Bell Laboratories layered Space Time), or MLD (Maximum Likelihood Detection).

The frequency-domain signals of individual layers resulting from demultiplexing are input to the switching units 311-1 to 311-L. The individual switching units 311-1 to 311-L change an output destination in accordance with the information regarding a transmission scheme input from the transmission scheme determination unit 327. Specifically, in a case where the information input from the transmission scheme determination unit 327 to the switching units 311 represents SC-FDMA (or Clustered DFT-S-OFDM), the switching units 311 input the values input thereto to the IDFT units 313. On the other hand, in a case where the information input from the transmission scheme determination unit 327 to the switching units 311 represents OFDM, the switching units 311 input the values input thereto to the demodulators 315.

The individual IDFT units 313-1 to 313-L perform inverse discrete Fourier transform on the frequency-domain signals input thereto, so as to transform the signals to time-domain signals, and inputs the obtained time-domain signals to the demodulators 315-1 to 315-L. The demodulators 315 convert reception symbols input from the IDFT units 313 or the switching units 311 to a bit sequence. The outputs of the demodulators 315 are input to the decoding units 317, where error correction decoding is applied. After that, the P/S converter 319 performs parallel-to-serial conversion on the outputs of the decoding units 317-1 to 317-L, and obtains a transmission data bit sequence.

The transmission scheme determination unit 327 illustrated in FIG. 8 determines whether the terminal device 1-2 uses SC-FDMA (or Clustered DFT-S-OFDM) or OFDM in uplink, in consideration of the allowable maximum transmission power of the terminal and power headroom (PH) for an amplifier, and inputs the determination result to the PMI determination unit 329 and the control information transmitter 331. Also, the transmission scheme determination unit 327 stores a transmission scheme used for previous uplink transmission, and inputs the transmission scheme to the switching units 311 so as to use it in reception processing.

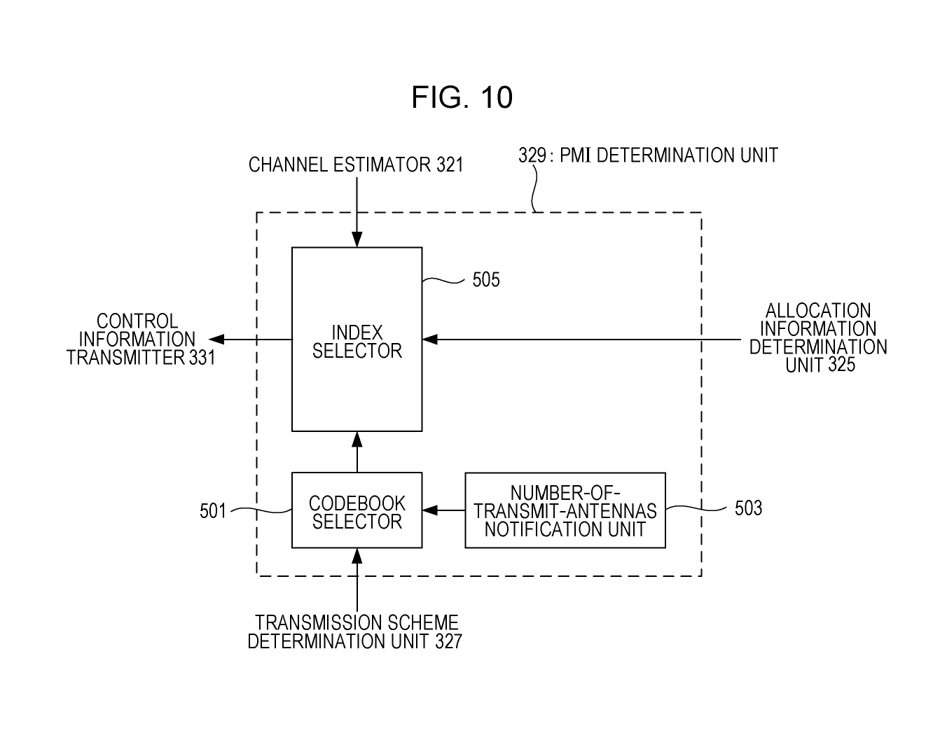

FIG. 10 is a schematic block diagram illustrating the configuration of the PMI determination unit 329 according to the first embodiment of the present invention. Processing performed by the PMI determination unit 329 will be described with reference to FIG. 10. An input from the transmission scheme determination unit 327 is input to a codebook selector 501. The codebook selector 501 selects a codebook in accordance with the input from the transmission scheme determination unit 327 and the number of transmit antennas of the terminal device 1-2 reported from a number-of-transmit-antennas notification unit 503. For example, in a case where the number of transmit antennas of the terminal device 1-2 is four and where the transmission scheme is SC-FDMA (or Clustered DFT-S-OFDM), the codebook illustrated in FIG. 5, which is a codebook that does not increase the CM of a transmit signal, is used.

On the other hand, in a case where the number of transmit antennas of the terminal device 1-2 is four and where the transmission scheme is OFDM, the CM of a transmit signal is sufficiently high and thus the CM is not changed by any types of precoding. Thus, in the case of OFDM, the codebook illustrated in FIG. 6 is used. In this way, in a case where the transmission scheme is SC-FDMA (Clustered DFT-S-OFDM), in which a CM is low, the codebook selector 501 selects a codebook for maintaining the CM. In a case where the transmission scheme is OFDM, in which a CM is high, the codebook selector 501 selects a codebook that enables acquisition of favorable transmit antenna gain, without the assumption of maintaining the CM.

The codebook selected by the codebook selector 501 is input to an index selector 505. Allocation information from the allocation information determination unit 325 and a channel estimation value from the channel estimator 321 have also been input to the index selector 505, and an optimal PMI is selected from the codebook in accordance with the channel to be used. For example, in a case where the codebook illustrated in FIG. 5 is input from the codebook selector 501, a certain precoding matrix is selected in consideration of the channel estimation value, the amount of data to be transmitted, and so forth, and the index thereof is determined.

Note that, in the case of the codebook illustrated in FIG. 5, only one precoding matrix of rank 4, codebook index=52, is defined. This is because the codebook illustrated in FIG. 5 is a codebook in which high priority is placed on maintaining a CM. On the other hand, in the case of the codebook illustrated in FIG. 6, a plurality of patterns are defined as precoding matrices of rank 4. The codebook illustrated in FIG. 6, in which a CM is not taken into consideration, enables more flexible precoding, and a larger transmit antenna diversity gain can be acquired.

The output of the index selector 505 is input to, as the output of the PMI determination unit 329, the control information transmitter 331 illustrated in FIG. 8. The control information transmitter 331 transmits, to the terminal device 1-2, the PMI input from the PMI determination unit 329, the information regarding the transmission scheme input from the transmission scheme determination unit 327, the information regarding the modulation scheme input from the modulation scheme determination unit 323, the information regarding spectrum allocation (allocation information) input from the allocation information determination unit 325, and other control information not illustrated (information regarding transmit power control, information regarding generation of a reference signal, etc.).

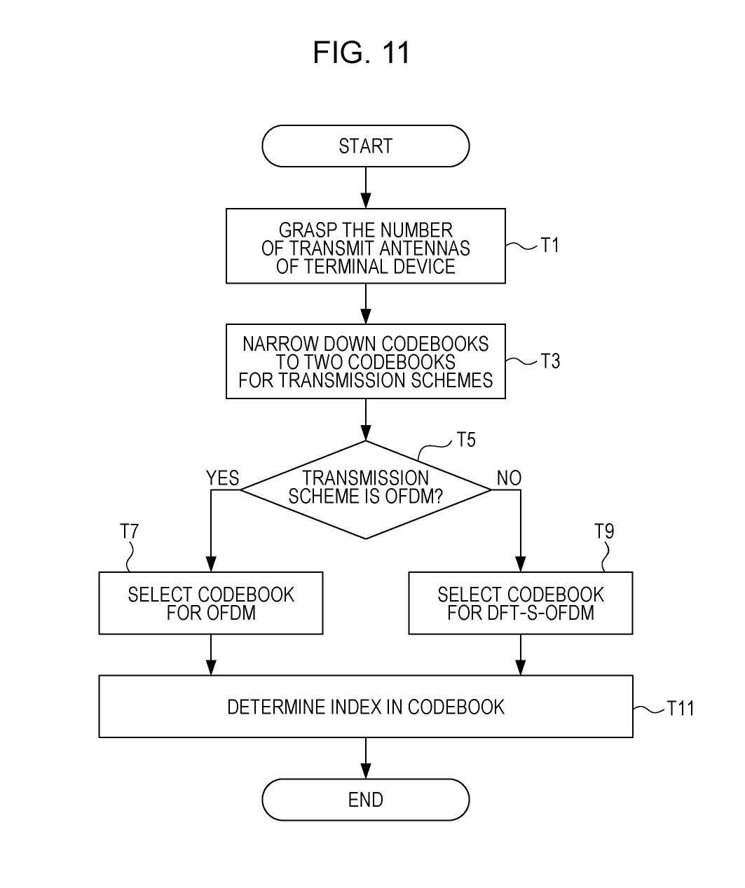

FIG. 11 is a flowchart illustrating processing performed within the PMI determination unit 329 illustrated in FIG. 10, according to the first embodiment of the present invention. First, the base station device 3 grasps the number of transmit antennas included in the terminal device 1-2 as a target (step T1). It is assumed that the base station device 3 is notified of the number of transmit antennas from the terminal device 1-2 in advance before communication is performed. Subsequently, the base station device 3 limits the codebooks to be used in accordance with the number of transmit antennas (step T3). At this stage, the codebooks are narrowed down to two codebooks for OFDM and DFT-S-OFDM. Subsequently, the base station device 3 judges whether or not the transmission scheme to be used for the next transmission by the terminal device 1-2 is OFDM or DFT-S-OFDM (step T5). In a case where the transmission scheme is OFDM (YES in step T5), the base station device 3 selects the codebook for OFDM (step T7). In a case where the transmission scheme is not OFDM (NO in step T5), the base station device 3 selects the codebook for DFT-S-OFDM (step T9). Finally, the base station device 3 determines the precoding matrix to be used for the next transmission by using a channel estimation value, allocation information, and the selected codebook (step T11), and regards the index of the precoding matrix as a PMI.

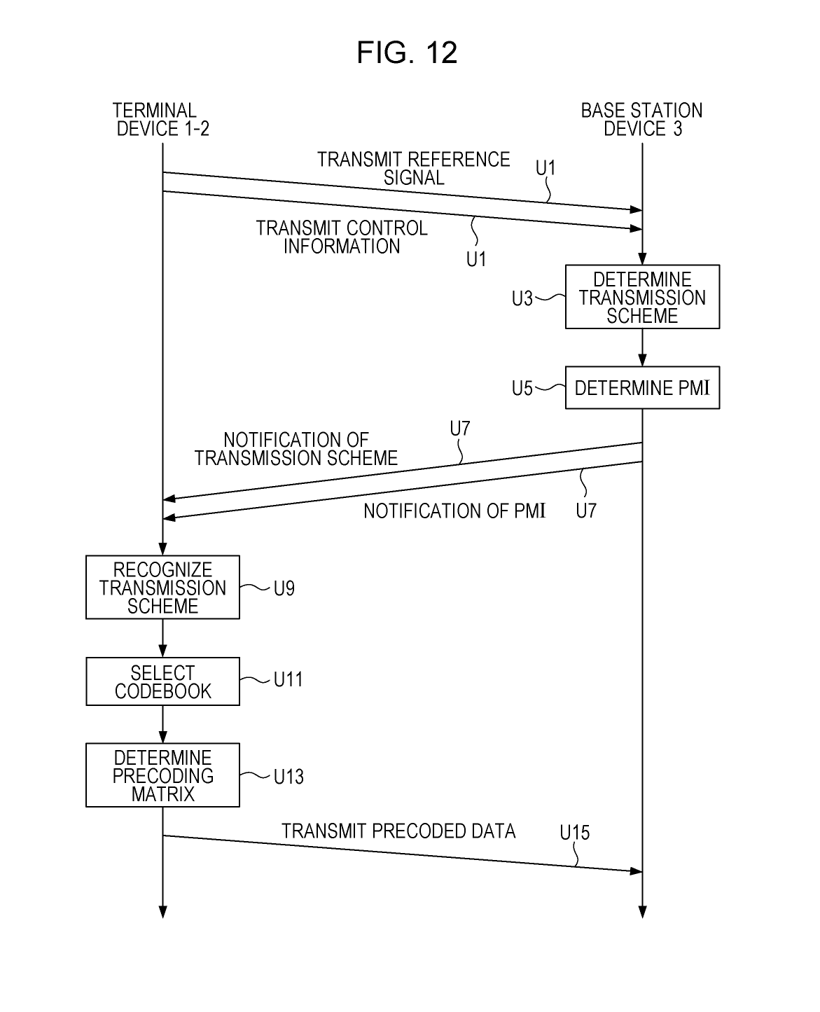

FIG. 12 is a sequence chart illustrating processing performed by the terminal device 1-2 and the base station device 3 according to the first embodiment of the present invention. First, the terminal device 1-2 transmits a reference signal and control information to the base station device 3 (step U1), and thereby the base station device 3 determines the transmission scheme to be used for the next uplink transmission (step U3), and determines, with the PMI determination unit 329 illustrated in FIG. 10, a PMI (step U5). The base station device 3 notifies the terminal device 1-2 of the information regarding the transmission scheme to be used for the next uplink transmission and the PMI that have been determined (step U7). The terminal device 1-2 recognizes, from the information regarding the transmission scheme, the transmission scheme to be used for the next uplink transmission (step U9), and selects a codebook (step U11) and determines a precoding matrix (step U13) by using the precoding matrix determination unit 133 illustrated in FIG. 4. The terminal device 1-2 multiplies the determined precoding matrix by data, and transmits the data (step U15).

As described above, in this embodiment, a codebook to be used is selected in accordance with not only the number of transmit antennas (the number of antenna ports) but also a transmission scheme. Thus, in a communication system in which a plurality of transmission schemes are defined, even if the same PMI is provided, different precoding operations can be performed in accordance with a transmission scheme to be used. As a result, precoding suitable for each transmission scheme can be performed. Accordingly, the throughput can be increased with the coverage being maintained, compared to the case of using the same precoding. Also, a codebook is selected depending on a selected transmission scheme, and thus it is not necessary to add information indicating which codebook is to be selected. As a result, the amount of downlink control information is not increased.

### Second Embodiment

In a second embodiment, a codebook is changed in accordance with whether the transmission scheme is SC-FDMA or Clustered. In the first embodiment, a description has been given under the assumption that transmission schemes with a low CM are SC-FDMA and Clustered DFT-S-OFDM and a transmission scheme with a high CM is OFDM. However, Clustered DFT-S-OFDM is a transmission scheme in which a CM is higher than in SC-FDMA. Thus, Clustered DFT-S-OFDM may be used as a transmission scheme with a high CM, and different codebooks may be used for SC-FDMA and Clustered DFT-S-OFDM. In the second embodiment, a description will be given of a case where SC-FDMA is used as a transmission scheme with a low CM and Clustered DFT-S-OFDM is used as a transmission scheme with a high CM.

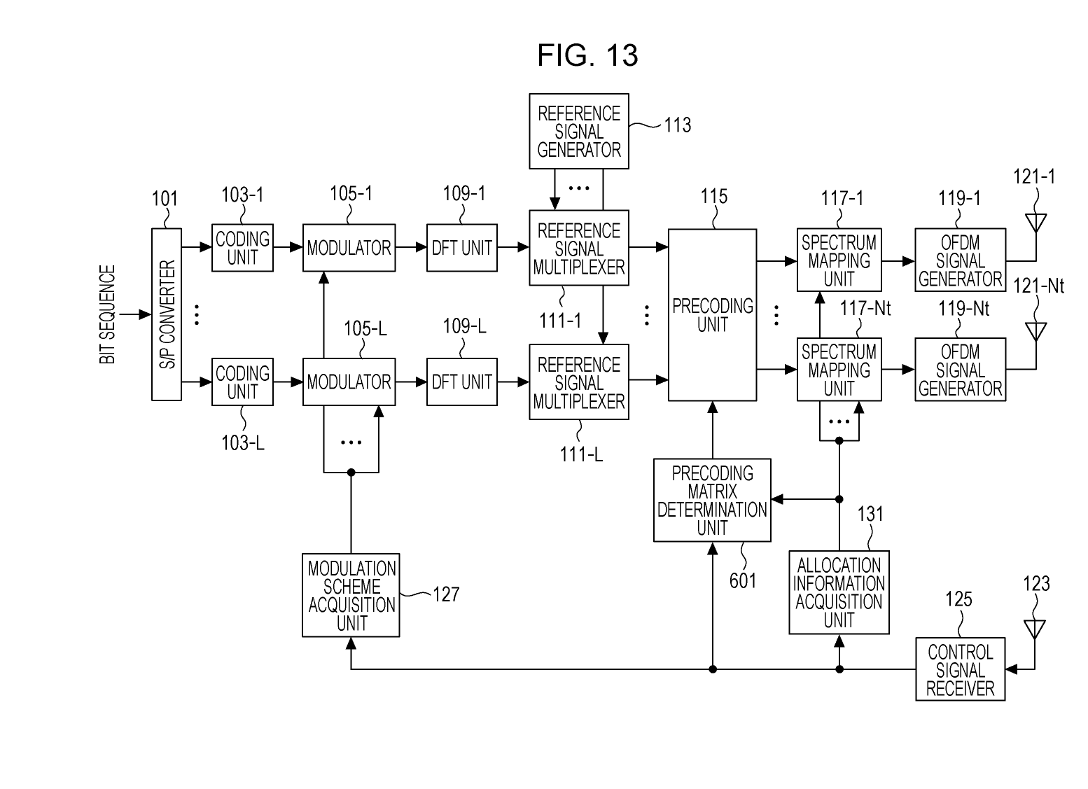

FIG. 13 is a schematic block diagram illustrating the communication device configuration of a terminal device 1 according to the second embodiment of the present invention. This configuration is almost the same as the transmitter configuration illustrated in FIG. 2 according to the first embodiment, and thus a description will be given of only blocks different therefrom. First, the switching units 107-1 to 107-L do not exist. This is because DFT processing performed by the DFT units 109 is necessary in both SC-FDMA and Clustered DFT-S-OFDM. In a case where OFDM exists as a transmission scheme as well as SC-FDMA and Clustered DFT-S-OFDM, the switching units 107 exist as in the first embodiment. The processing performed by the DFT units 109 and the subsequent stage is similar to that of the first embodiment, and transmission from an antenna unit is performed.

On the other hand, the control information received by the control signal receiver 125 is input to the allocation information acquisition unit 131, a precoding matrix determination unit 601, and the modulation scheme acquisition unit 127. The allocation information acquisition unit 131 extracts allocation information (scheduling information) from the control information input thereto, and inputs the allocation information to the spectrum mapping units 117-1 to 117-Nt and the precoding matrix determination unit 601. The spectrum mapping units 117-1 to 117-Nt map the spectrum input from the precoding unit 115 to frequencies within a system band, on the basis of the allocation information input thereto.

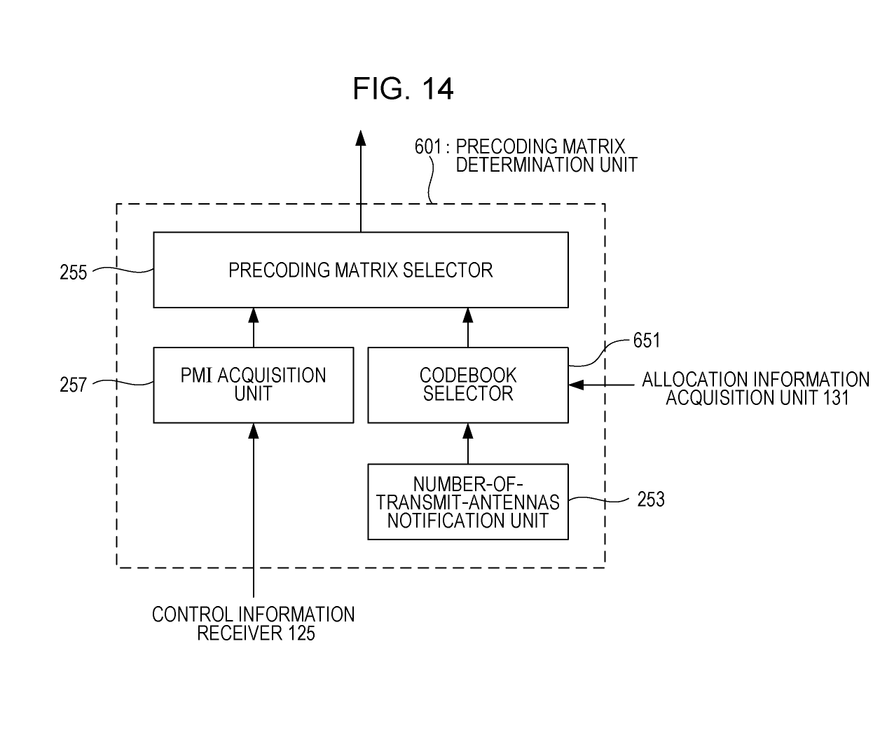

Next, processing performed by the precoding matrix determination unit 601 will be described. FIG. 14 is a schematic block diagram illustrating the configuration of the precoding matrix determination unit 601 according to the second embodiment of the present invention. An input from the allocation information acquisition unit 131 is input to a codebook selector 651. The codebook selector 651 selects a plurality of codebooks in accordance with the number of transmit antennas (the number of antenna ports) of the terminal device 1 reported from the number-of-transmit-antennas notification unit 253, and further selects a certain codebook in accordance with the allocation information input from the allocation information acquisition unit 131.

For example, in a case where the allocation information input from the allocation information acquisition unit 131 represents contiguous arrangement, that is, in a case where the transmission scheme is SC-CDMA, a codebook in which high priority is placed on maintaining a CM, such as the codebook illustrated in FIG. 5, is selected. In a case where the allocation information input from the allocation information acquisition unit 131 represents noncontiguous arrangement, that is, in a case where the transmission scheme is Clustered DFT-S-OFDM, a codebook that enables acquisition of favorable transmit antenna gain, such as the codebook illustrated in FIG. 6, is selected. The selected codebook is input to the precoding matrix selector 255.

Clustered DFT-S-OFDM has a characteristic that a CM increases as the number of clusters increases. Thus, a codebook may be provided in accordance with the number of clusters of Clustered DFT-S-OFDM. That is, according to the present invention, in a case where the transmission scheme is SC-FDMA, or Clustered DFT-S-OFDM in which the number of clusters is two, a codebook that does not increase a CM may be used and, in a case where the number of clusters is three or more, a codebook with which transmit antenna diversity gain is high may be changed. According to the description given above, two codebooks are provided. Alternatively, three or more codebooks may be provided in a system in accordance with the number of clusters of Clustered DFT-S-OFDM.

The PMI acquisition unit 257 extracts a PMI from the control information input from the control signal receiver 125, and inputs the PMI to the precoding matrix selector 255. The precoding matrix selector 255 selects the precoding matrix corresponding to the PMI in the codebook input from the codebook selector 651, and inputs the precoding matrix to, as the output of the precoding matrix determination unit 601, the precoding unit 115.

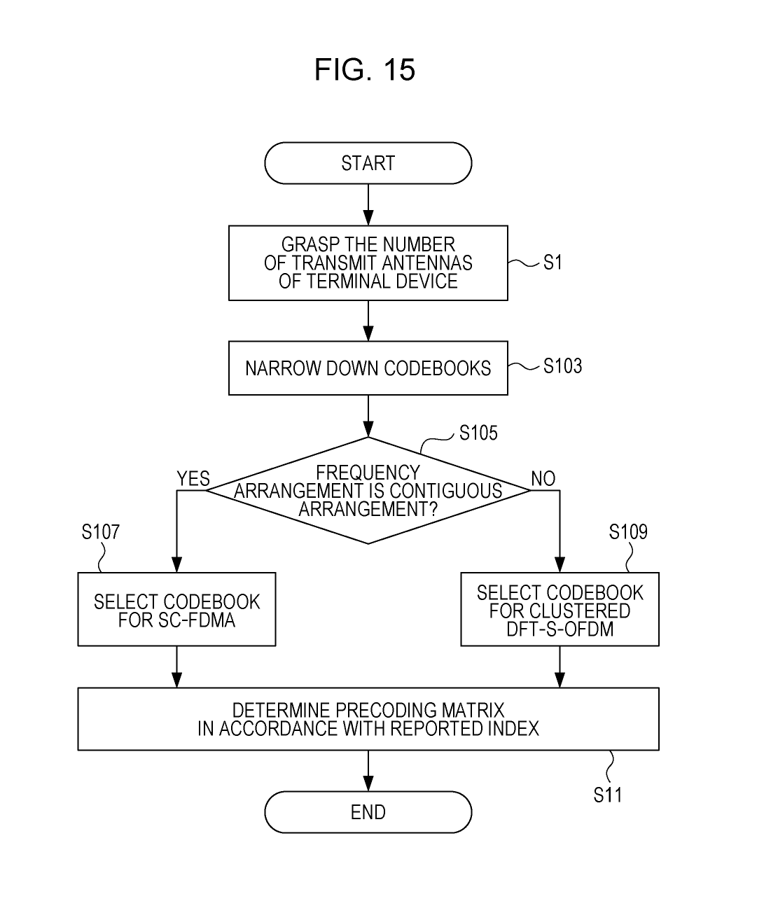

FIG. 15 is a flowchart illustrating processing performed within the precoding matrix determination unit 601 illustrated in FIG. 14 according to the second embodiment of the present invention. The same steps as in FIG. 7 are denoted by the same numerals. First, the terminal device 1 grasps the number of transmit antennas included in the terminal device 1 (step S1). Subsequently, the terminal device 1 limits the codebooks to be used in accordance with the number of transmit antennas (step S103). Subsequently, the terminal device 1 judges whether or not frequency arrangement is contiguous arrangement (step S105). In a case where frequency arrangement is contiguous arrangement (YES in step S105), the terminal device 1 selects the codebook for SC-FDMA (step S107). In a case where frequency arrangement is not contiguous arrangement (NO in step S105), the terminal device 1 selects the codebook for Clustered DFT-S-OFDM (step S109). Finally, the terminal device 1 determines the precoding matrix to be used for the next transmission in accordance with the selected codebook and the PMI reported from the base station device 3 (step S11), and performs the next transmission by using the determined precoding matrix.

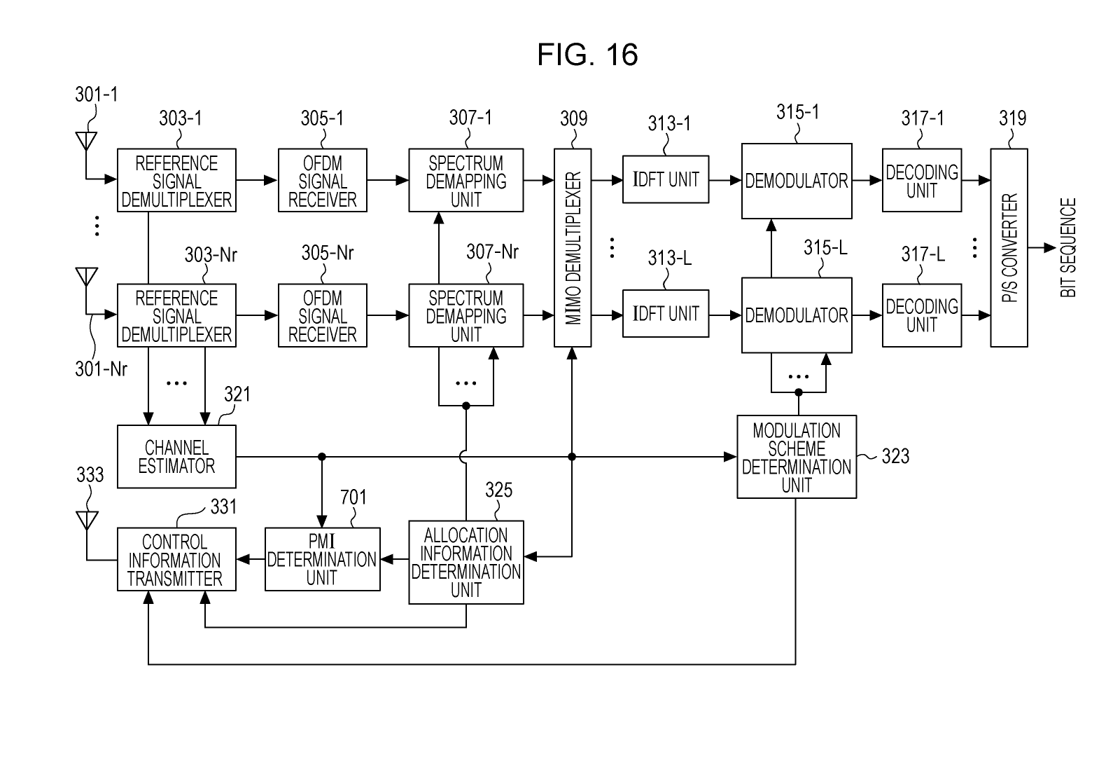

FIG. 16 is a schematic block diagram illustrating the receiver configuration of the base station device 3 according to the second embodiment of the present invention. This configuration is almost the same as the configuration illustrated in FIG. 8 according to the first embodiment, and thus a description will be given of only blocks different therefrom. Since OFDM is not used as a transmission scheme, the switching units 311-1 to 311-L do not exist as in the terminal configuration, and the output of the MIMO demultiplexer 309 is input to the IDFT units 313-1 to 313-L.

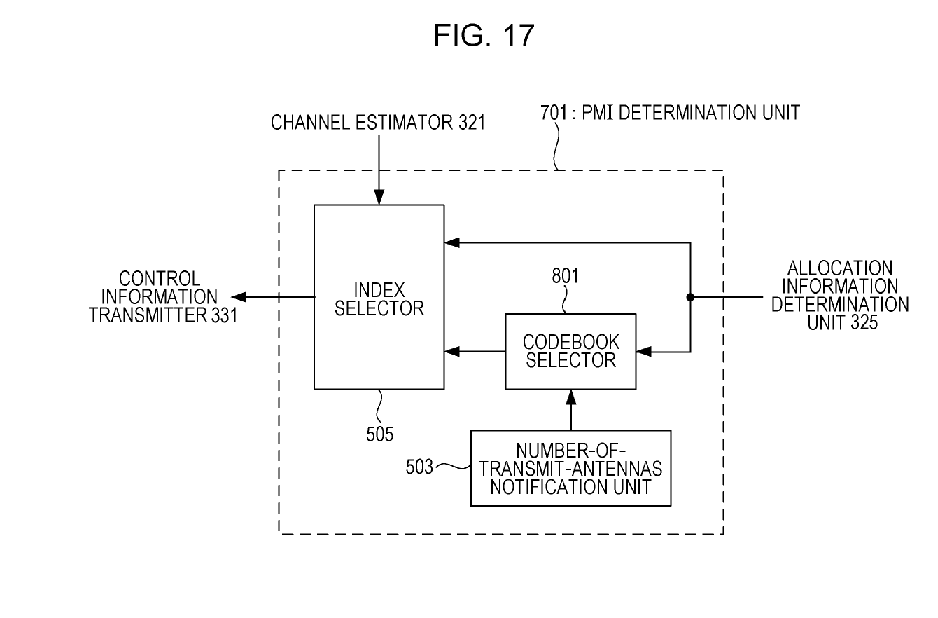

The configuration of a PMI determination unit 701 is different from that of the first embodiment, and thus the description thereof will be given with reference to FIG. 17. FIG. 17 is a schematic block diagram illustrating the configuration of the PMI determination unit 701 according to the second embodiment of the present invention. The allocation information input from the allocation information determination unit 325 is input to a codebook selector 801 and the index selector 505. The codebook selector 801 selects, from among a plurality of codebooks, a plurality of codebooks in accordance with the number of transmit antennas (the number of antenna ports) of the terminal device 1 reported from the number-of-transmit-antennas notification unit 503, and furthermore, selects a certain codebook in accordance with the allocation information input from the allocation information determination unit 325.

For example, in a case where the allocation information represents contiguous arrangement (that is, the transmission scheme is SC-FDMA), a codebook constituted by precoding matrices in which high priority is placed on maintaining a CM, as in FIG. 5, is selected. In a case where the allocation information represents noncontiguous arrangement (that is, the transmission scheme is Clustered DFT-S-OFDM), a codebook constituted by precoding matrices in which high priority is placed on transmit antenna diversity gain, as in FIG. 6, is selected. The selected codebook is input to the index selector 505. The index selector 505 determines which precoding matrix in the codebook is to be used for uplink transmission, by using the channel estimation value input from the channel estimator 321, the codebook input from the codebook selector 801, and the allocation information input from the allocation information determination unit 325, and inputs the index of the precoding matrix to the control information transmitter 331.

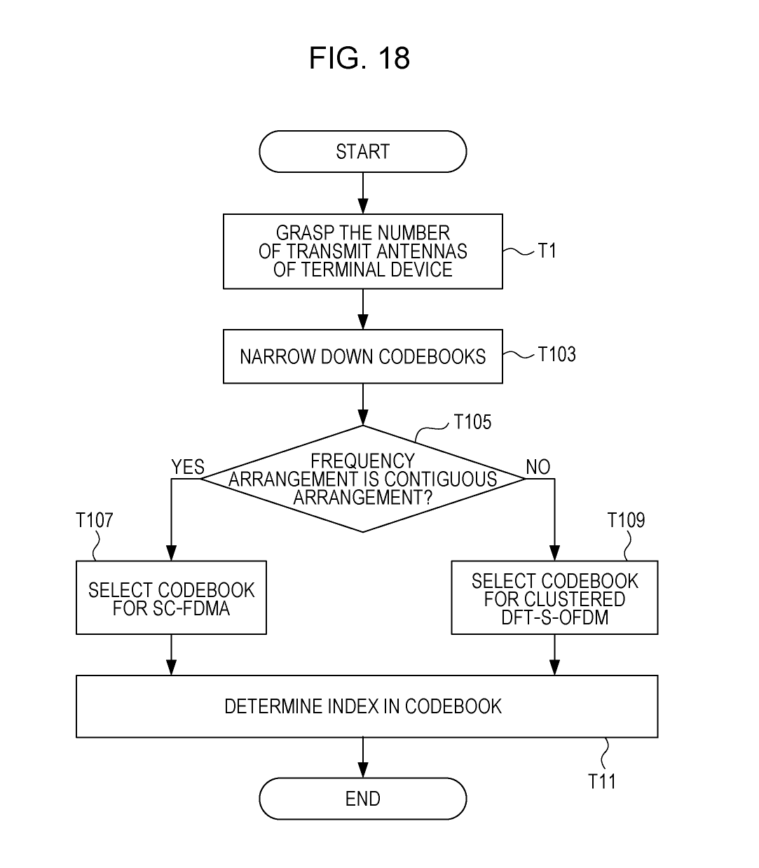

FIG. 18 is a flowchart illustrating processing performed within the PMI determination unit 701 illustrated in FIG. 17 according to the second embodiment of the present invention. The same steps as in FIG. 11 are denoted by the same numerals. First, the base station device 3 grasps the number of transmit antennas included in the terminal device 1 as a target (step T1). It is assumed that the base station device 3 is notified of the number of transmit antennas from the terminal device 1 in advance before communication is performed. Subsequently, the base station device 3 limits the codebooks to be used in accordance with the number of transmit antennas (step T103). Subsequently, the base station device 3 judges whether or not frequency arrangement is contiguous arrangement (step T105). In a case where frequency arrangement is contiguous arrangement (YES in step T105), the base station device 3 selects the codebook for SC-FDMA (step T107). In a case where frequency arrangement is not contiguous arrangement (NO in step T105), the base station device 3 selects the codebook for Clustered DFT-S-OFDM (step T109). Finally, the base station device 3 determines the precoding matrix to be used for the next transmission by using a channel estimation value, allocation information, and the selected codebook (step T11), and regards the index of the precoding matrix as a PMI.

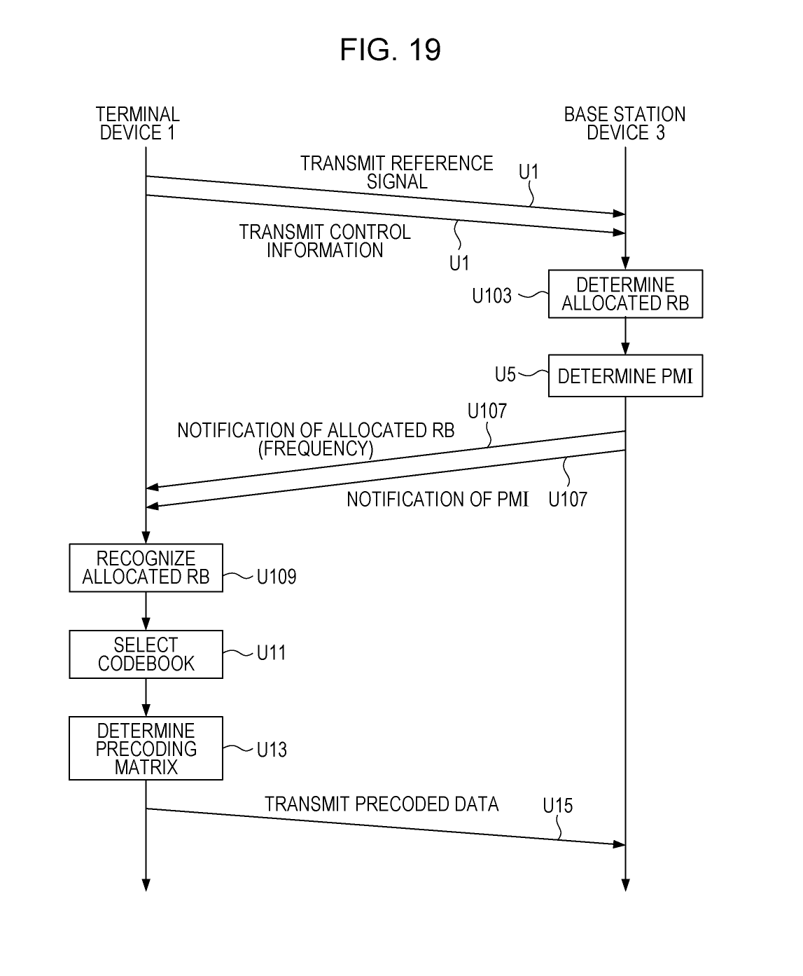

FIG. 19 is a sequence chart illustrating processing performed by the terminal device 1 and the base station device 3 according to the second embodiment of the present invention. First, the terminal device 1 transmits a reference signal and control information to the base station device 3 (step U1), and thereby the base station device 3 determines the allocated RB to be used for the next uplink transmission (step U103), and determines, with the PMI determination unit 701 illustrated in FIG. 17, a PMI (step U5). The base station device 3 notifies the terminal device 1 of the allocated RB (frequency) to be used for the next uplink transmission and the PMI that have been determined (step U107). The terminal device 1 recognizes, from the information regarding the transmission scheme, the allocated RB to be used for the next uplink transmission (step U109), and selects a codebook (step U11) and determines a precoding matrix (step U13) by using the precoding matrix determination unit 601 illustrated in FIG. 14. The terminal device 1 multiplies the determined precoding matrix by data, and transmits the data (step U15).

Unlike in OFDM, typically, in Clustered DFT-S-OFDM, a CM increases by precoding. In FIG. 6, the amount of increase in CM is statistically constant in all the plurality of precoding matrices used for performing transmission of a certain rank in the codebook. Alternatively, precoding matrices having different amounts of increase in CM may be included in a codebook. For example, in FIG. 6, twelve precoding matrices corresponding to indexes 4 to 15 are provided as precoding matrices of rank 2, and all of these precoding matrices are not of CMP type. Alternatively, four precoding matrices among the twelve precoding matrices may be replaced with those of CMP type, and the other eight precoding matrices may be those in which a CM increases. If such a codebook is provided, the base station device 3 is capable of selecting a precoding matrix that does not cause an excessive increase in CM of a transmit signal of the terminal device 1, in accordance with, for example, the magnitude of PH reported by the terminal device 1 to the base station device 3.

As described above, in a case where a spectrum is contiguously allocated, the PMI determination unit 701 according to this embodiment operates to perform precoding for maintaining a CM. In a case where a spectrum is noncontiguously allocated, a CM is increased to some extent regardless of precoding, and thus the PMI determination unit 701 operates to perform precoding for allowing an increase in CM and increasing transmit antenna diversity gain. As a result, compared to the case of using a codebook constituted by only precoding matrices for maintaining a CM, the transmission performances of the terminal device 1 for which degradation in CM is not important can be improved with the coverage being maintained, and thus cell throughput can be increased.

In the second embodiment, a codebook for precoding is selected in accordance with whether a transmit signal is based on SC-FDMA or Clustered DFT-S-OFDM. Alternatively, a codebook constituted by only precoding matrices for maintaining a CM may be used for SC-FDMA. For Clustered DFT-S-OFDM, a codebook constituted by precoding matrices for maintaining a CM or a codebook constituted by precoding matrices in which high priority is placed on transmit antenna diversity gain may be selected in accordance with the state of the spectrum mapping.

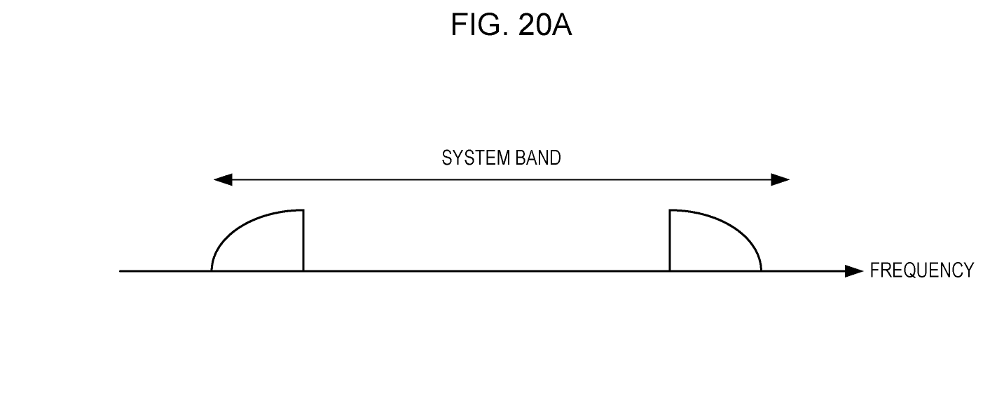

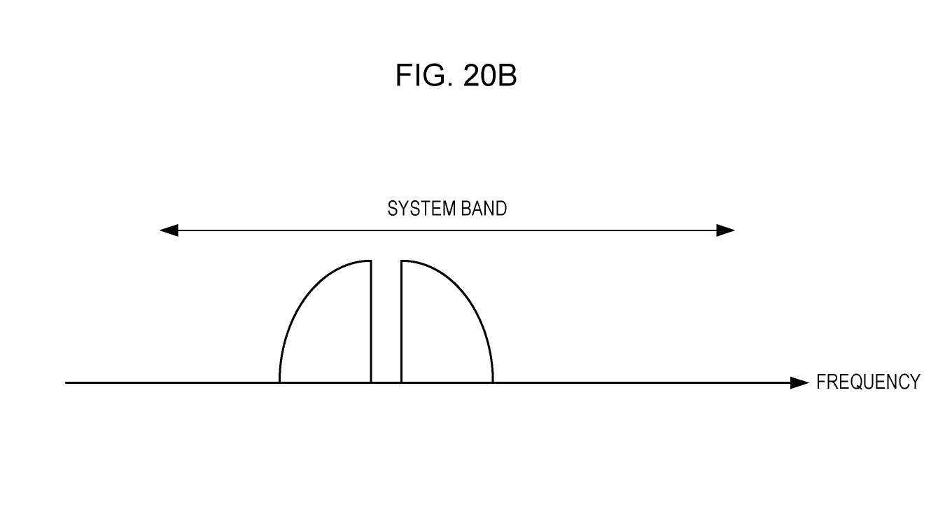

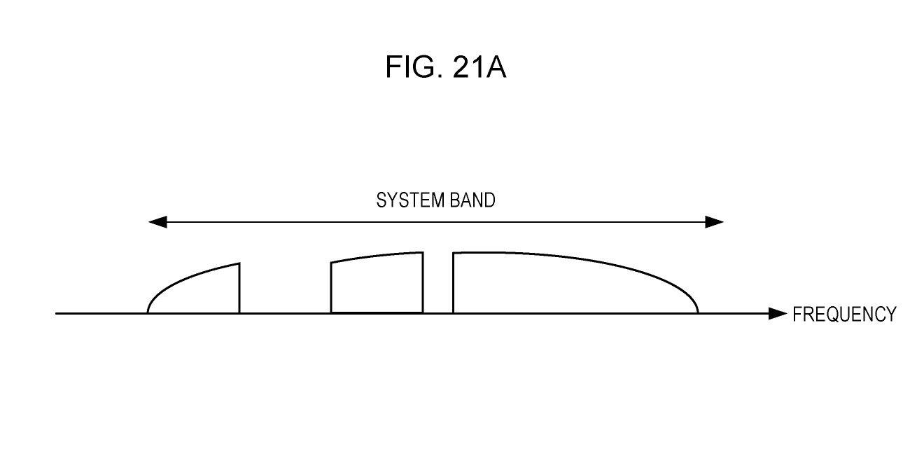

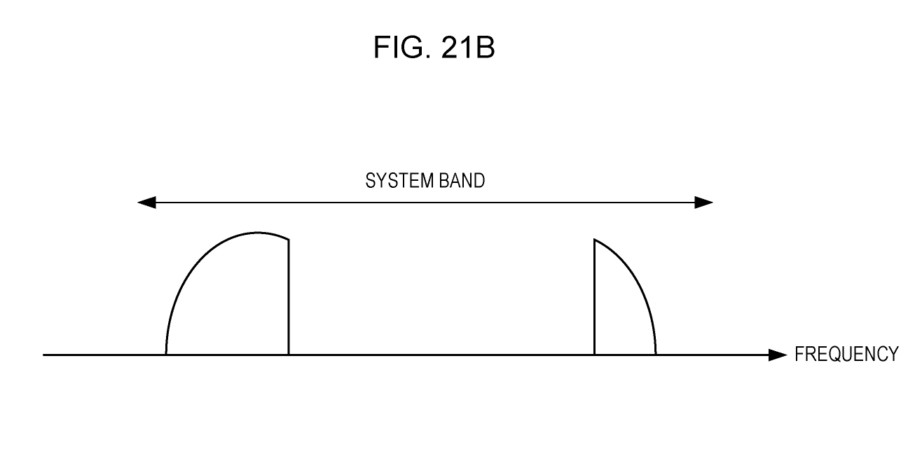

FIGS. 20A, 20B, 21A, and 21B are schematic diagrams of a system band in which clusters are arranged. For example, in Clustered DFT-S-OFDM constituted by two clusters, in a case where the clusters are separated from each other as in FIG. 20A, an influence of emission to the outside of the system band on a spectrum mask is large, and thus it is necessary to perform transmission with suppressed power. As a result, transmission is performed with decreased average transmission power, and thus amplification can be performed within a linear region of an amplifier even if peak power is increased. Thus, a codebook constituted by precoding matrices in which high priority is placed on transmit antenna diversity gain is selected. On the other hand, in a case where the clusters are close to each other, as in FIG. 20B, an influence of emission to the outside of the system band on a spectrum mask can be suppressed compared to the case of FIG. 20A, and thus it is not necessary to perform transmission with suppressed power. In this case, transmission is performed with increased average transmission power, and thus excess over the linear region of the amplifier occurs if peak power is increased. Thus, a codebook constituted by precoding matrices for maintaining a CM is selected.

As described above, according to the present invention, a codebook constituted by precoding matrices in which high priority is placed on transmit antenna diversity gain is selected in a case where the value of the distance between clusters is larger than a certain value, and a codebook constituted by precoding matrices for maintaining a CM is selected in a case where the value of the distance between clusters is smaller than the certain value. In a case where the bandwidth that is used is large with respect to the system band as in FIG. 21A, there is a high probability that the distance between clusters is small. In a case where the bandwidth that is used is small with respect to the system band as in FIG. 21B, there is a high probability that the distance between clusters is large. Thus, the bandwidth that is used with respect to the system band may be calculated, and a codebook to be used may be selected in accordance with the ratio.

### Third Embodiment

In a third embodiment, a codebook is changed in accordance with a modulation scheme. In the first and second embodiments, a description has been given of the case of changing the precoding method in accordance with a transmission scheme because a CM varies depending on a transmission scheme. Here, it is not only when a transmission scheme is changed that a CM changes.

For example, in LTE-A, a transmission scheme that is called carrier aggregation and that is based on N×DFT-S-OFDM, in which a plurality of LTE component carriers are simultaneously used, is specified. In the case of amplifying a plurality of component carriers using a single amplifier, a CM increases. In LTE Rel-8, PUSCH (Physical Uplink Shared CHannel) for transmitting data and PUCCH (Physical Uplink Control CHannel) for transmitting control information cannot be simultaneously transmitted. However, in LTE Rel-10, simultaneous transmission of PUSCH and PUCCH is specified. At this time, two signals are simultaneously transmitted from a single antenna, and thus the transmit signal is a multi-carrier signal. As a result, the CM of the transmit signal increases. In other than carrier aggregation and simultaneous transmission of PUSCH and PUCCH, a CM changes depending on a modulation scheme to be used. In this embodiment, a description will be given of a modulation scheme, as another case where a CM is changed.

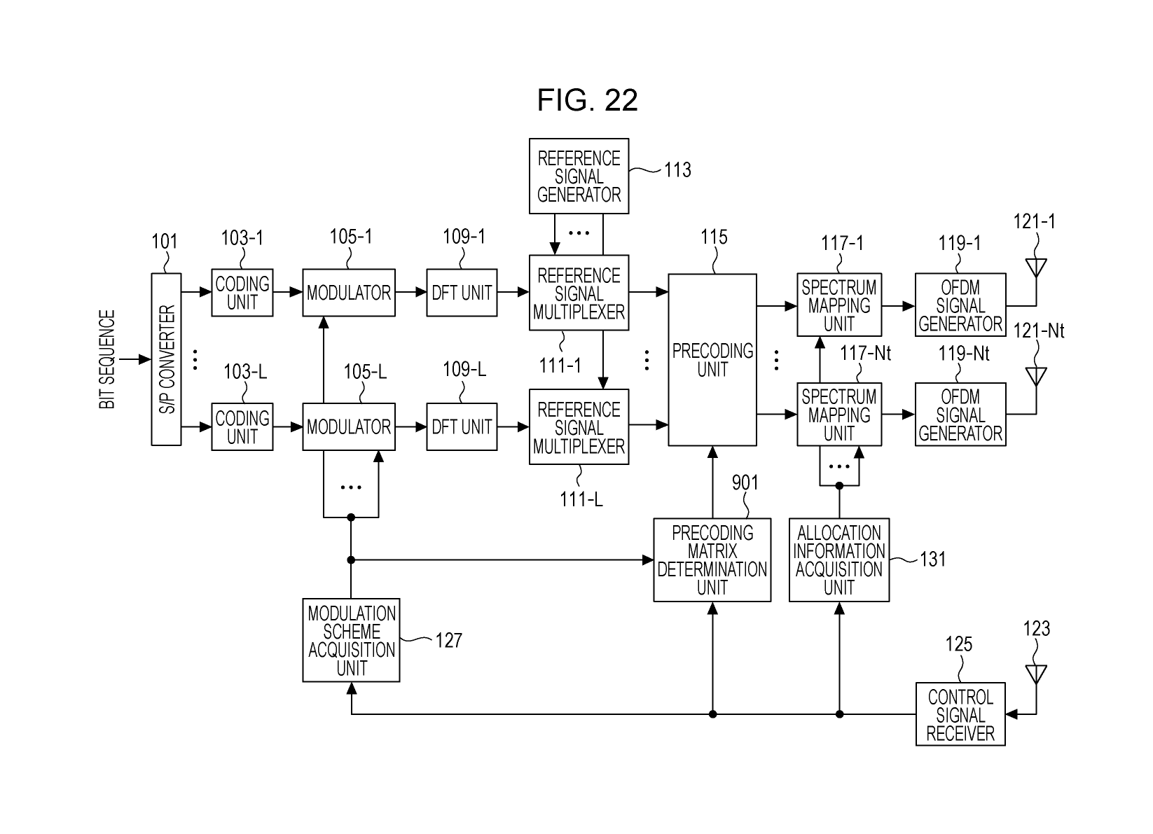

FIG. 22 is a schematic block diagram illustrating the transmitter configuration of the terminal device 1 according to the third embodiment of the present invention. This configuration is almost the same as the transmitter configuration illustrated in FIG. 13 according to the second embodiment, and thus a description will be given of only blocks different therefrom. A different point is input to a precoding matrix determination unit 901 and processing performed therein, and a description will be given of this point. In the second embodiment, a codebook to be selected varies depending on the allocation of a spectrum (whether SC-FDMA or Clustered DFT-S-OFDM), and thus the output of the allocation information acquisition unit 131 is input to the precoding matrix determination unit 901. On the other hand, in this embodiment, a codebook to be selected is changed in accordance with a modulation scheme, and thus the information regarding a modulation scheme is input from the modulation scheme acquisition unit 127 to the precoding matrix determination unit 901.

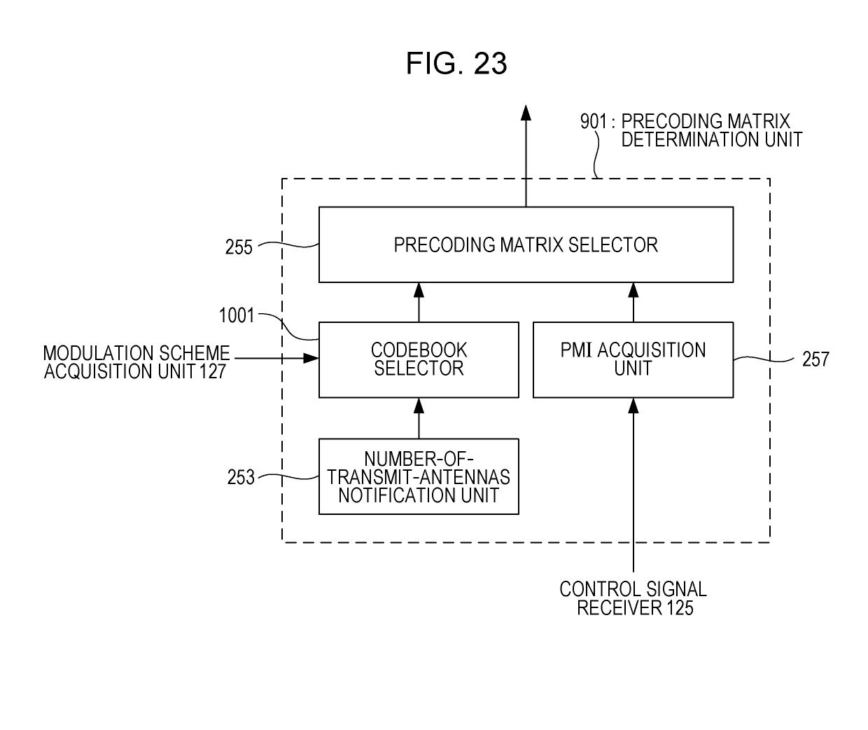

Next, a description will be given of an example of internal processing performed by the precoding matrix determination unit 901, with reference to FIG. 23. FIG. 23 is a schematic block diagram illustrating the configuration of the precoding matrix determination unit 901 according to the third embodiment of the present invention. An input from the modulation scheme acquisition unit 127 is input to a codebook selector 1001. The codebook selector 1001 selects, from among a plurality of codebooks, a plurality of codebooks in accordance with the number of transmit antennas (the number of antenna ports) of the terminal device 1 reported from the number-of-transmit-antennas notification unit 253, and further selects a certain codebook in accordance with a modulation scheme input from the modulation scheme acquisition unit 127.

For example, in a case where the modulation scheme input from the modulation scheme acquisition unit 127 is a scheme of a low CM, such as BPSK, QPSK, 8PSK, or 16PSK, a codebook in which high priority is placed on maintaining a CM, as in FIG. 5, is selected. In a case where the modulation scheme input from the modulation scheme acquisition unit 127 is a scheme of a high CM, such as 16QAM, 64QAM in which a CM is higher than in 16QAM, or 256QAM, a codebook that enables acquisition of favorable transmit antenna gain, as in FIG. 6, is selected. The selected codebook is input to the precoding matrix selector 255. According to the description given above, 16QAM is regarded as a modulation scheme of a high CM. However, whether a CM is high or low is relatively determined. Thus, according to the present invention, 64QAM or more may be regarded as a modulation scheme of a high CM.

An input from the control signal receiver 125 is input to the PMI acquisition unit 257, which extracts a PMI from the control information, and inputs the acquired PMI to the precoding matrix selector 255. The precoding matrix selector 255 selects a precoding matrix corresponding to the PMI from the codebook input from the codebook selector 1001, and inputs the precoding matrix to, as the output of the precoding matrix determination unit 901, the precoding unit 115.

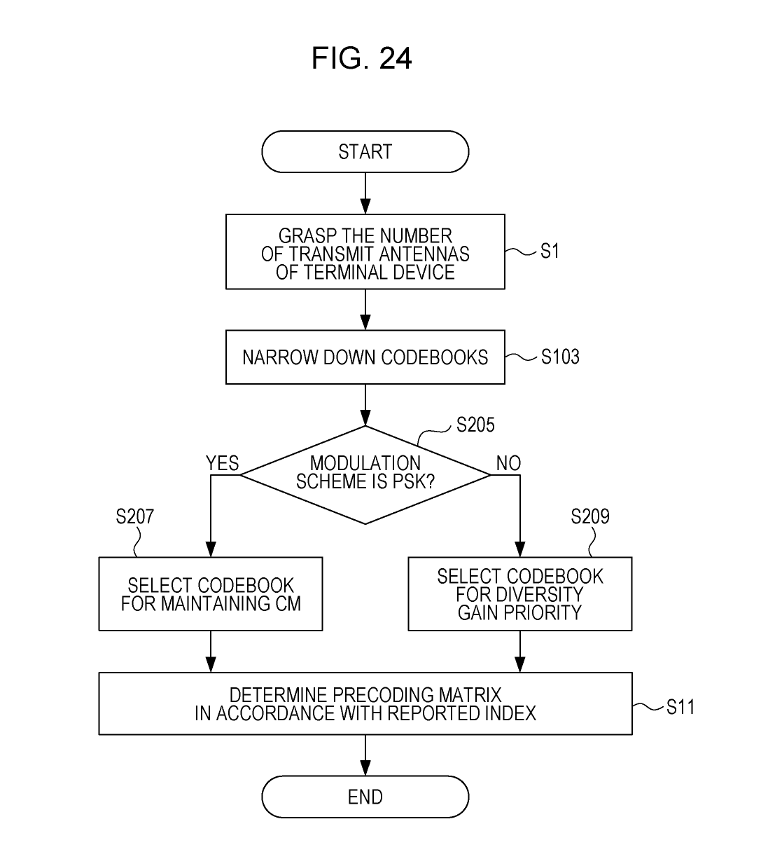

FIG. 24 is a flowchart illustrating processing performed within the precoding matrix determination unit 901 illustrated in FIG. 23 according to the third embodiment of the present invention. The same steps as in FIGS. 7 and 15 are denoted by the same numerals. First, the terminal device 1 grasps the number of transmit antennas included in the terminal device 1 (step S1). Subsequently, the terminal device 1 limits the codebooks to be used, in accordance with the number of transmit antennas (step S103). Subsequently, the terminal device 1 judges whether or not the modulation scheme is PSK (step S205). In a case where the modulation scheme is PSK (YES in step S205), the terminal device 1 selects a codebook for maintaining a CM (step S207). In a case where the modulation scheme is not PSK (NO in step S205), the terminal device 1 selects a codebook for diversity gain priority (step S209). Finally, the terminal device 1 determines the precoding matrix to be used for the next transmission in accordance with the selected codebook and the PMI reported from the base station device 3 (step S11), and performs the next transmission by using the determined precoding matrix.

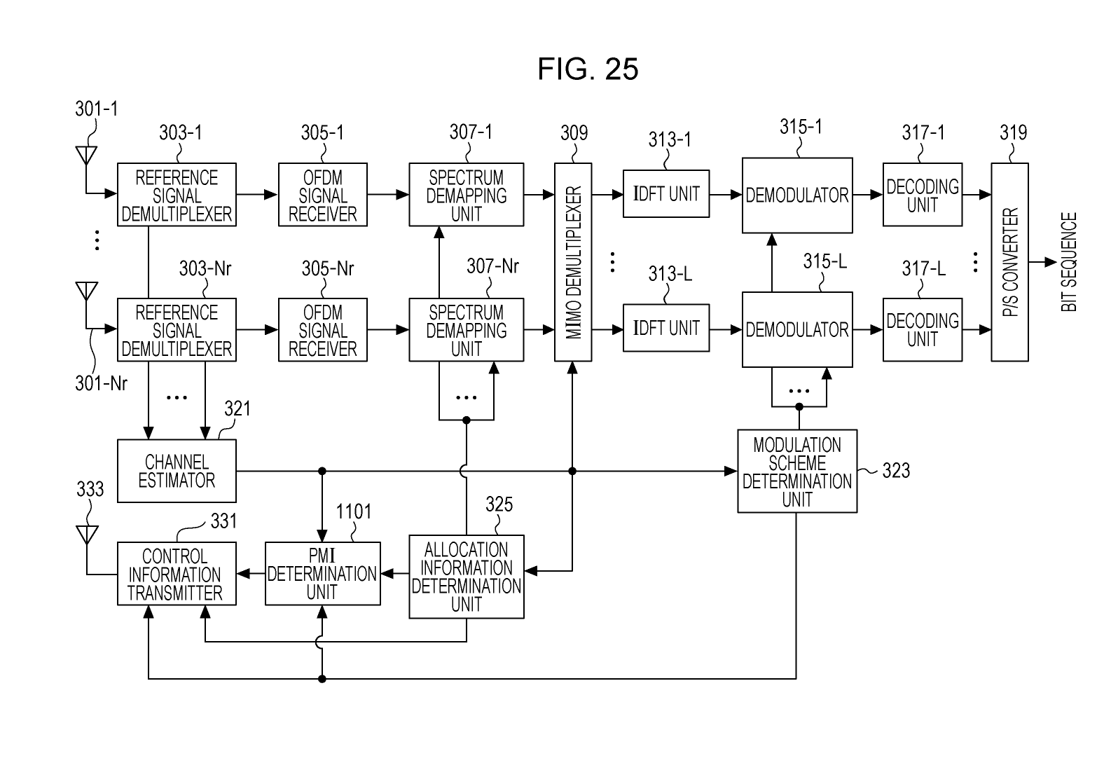

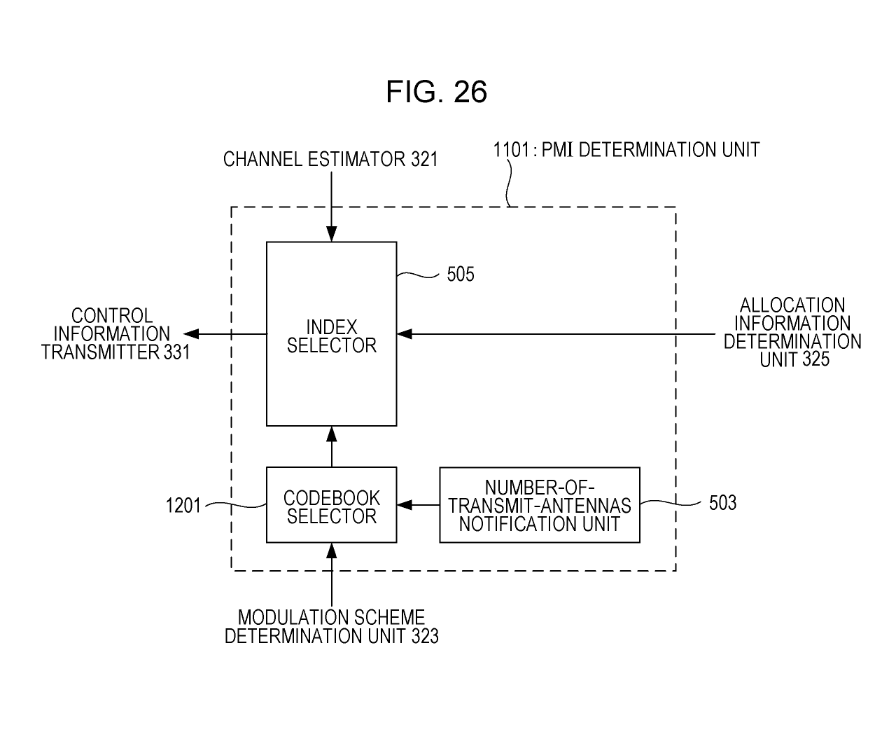

FIG. 25 illustrates an example of the receiver configuration of the base station device 3 according to this embodiment. FIG. 25 is a schematic block diagram illustrating the receiver configuration of the base station device 3 according to the third embodiment of the present invention. This configuration is almost the same as the configuration illustrated in FIG. 16 according to the second embodiment. However, input to a PMI determination unit 1101 and internal processing performed therein are different. The PMI determination unit 1101 receives an input from the modulation scheme determination unit 323, as well as a channel estimation value input from the channel estimator 321 and allocation information input from the allocation information determination unit 325. A description will be given of the internal processing performed by the PMI determination unit 1101, with reference to FIG. 26. FIG. 26 is a schematic block diagram illustrating the configuration of the PMI determination unit 1101 according to the third embodiment of the present invention. The information input from the modulation scheme determination unit 323 is input to a codebook selector 1201.

The codebook selector 1201 selects, from among a plurality of codebooks, a plurality of codebooks in accordance with the number of transmit antennas (the number of antenna ports) of the terminal device 1 reported from the number-of-transmit-antennas notification unit 503, and further selects a certain codebook in accordance with the modulation scheme input from the modulation scheme determination unit 323. That is, in a case where the modulation scheme input from the modulation scheme determination unit 323 is a scheme of a low CM (for example, BPSK or QPSK), a codebook constituted by precoding matrices in which high priority is placed on maintaining a CM, as in FIG. 5, is selected. In a case where the modulation scheme is a scheme of a high CM (for example, 64QAM or 256QAM), a codebook that enables acquisition of favorable transmit antenna gain, as in FIG. 6, is selected.

The selected codebook is input to the index selector 505. The index selector 505 determines which precoding matrix in the codebook is to be used for uplink transmission, by using the channel estimation value input from the channel estimator 321, the codebook input from the codebook selector 1201, and the allocation information input from the allocation information determination unit 325, and inputs the index thereof to the control information transmitter 331. As described above, in a case where a modulation scheme of a low CM is used, the PMI determination unit 1101 according to this embodiment operates to perform precoding for maintaining a CM. In a case where a modulation scheme of a high CM is used, a CM is increased to some extent regardless of precoding, and thus the PMI determination unit 1101 operates to perform precoding for allowing an increase in CM and increasing transmit antenna diversity gain.

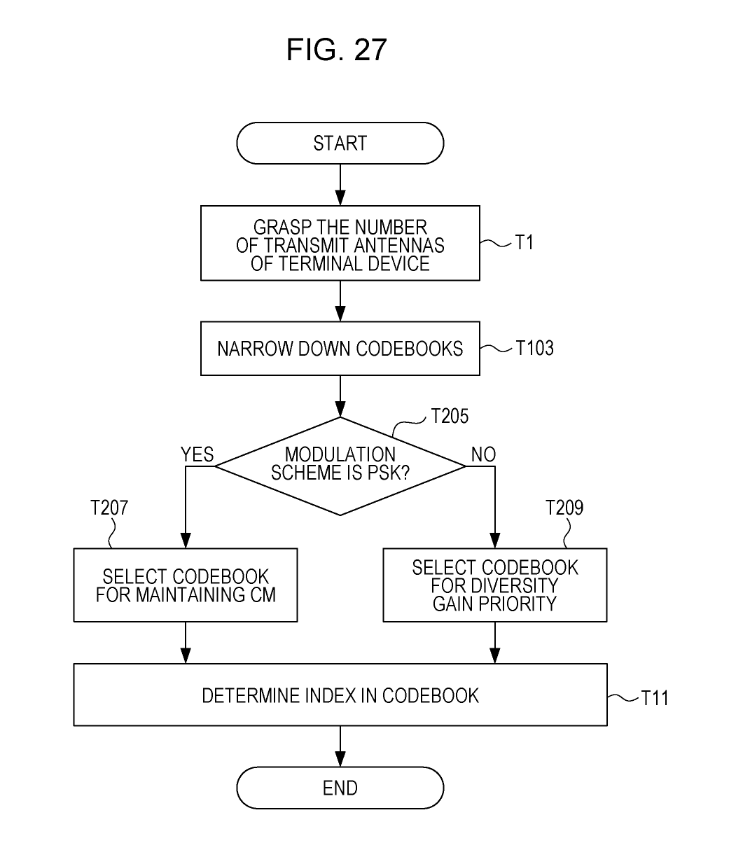

FIG. 27 is a flowchart illustrating processing performed within the PMI determination unit 1101 illustrated in FIG. 26 according to the third embodiment of the present invention. The same steps as in FIGS. 11 and 18 are denoted by the same numerals. First, the base station device 3 grasps the number of transmit antennas included in the terminal device 1 as a target (step T1). It is assumed that the base station device 3 is notified of the number of transmit antennas from the terminal device 1 in advance before communication is performed. Subsequently, the base station device 3 limits the codebooks to be used in accordance with the number of transmit antennas (step T103). Subsequently, the base station device 3 judges whether or not the modulation scheme is PSK (step T205). In a case where the modulation scheme is PSK (YES in step T205), the base station device 3 selects the codebook for maintaining a CM (step T207). In a case where the modulation scheme is not PSK (NO in step T205), the base station device 3 selects the codebook for diversity gain priority (step T209). Finally, the base station device 3 determines the precoding matrix to be used for the next transmission by using a channel estimation value, allocation information, and the selected codebook (step T11), and regards the index of the precoding matrix as a PMI.

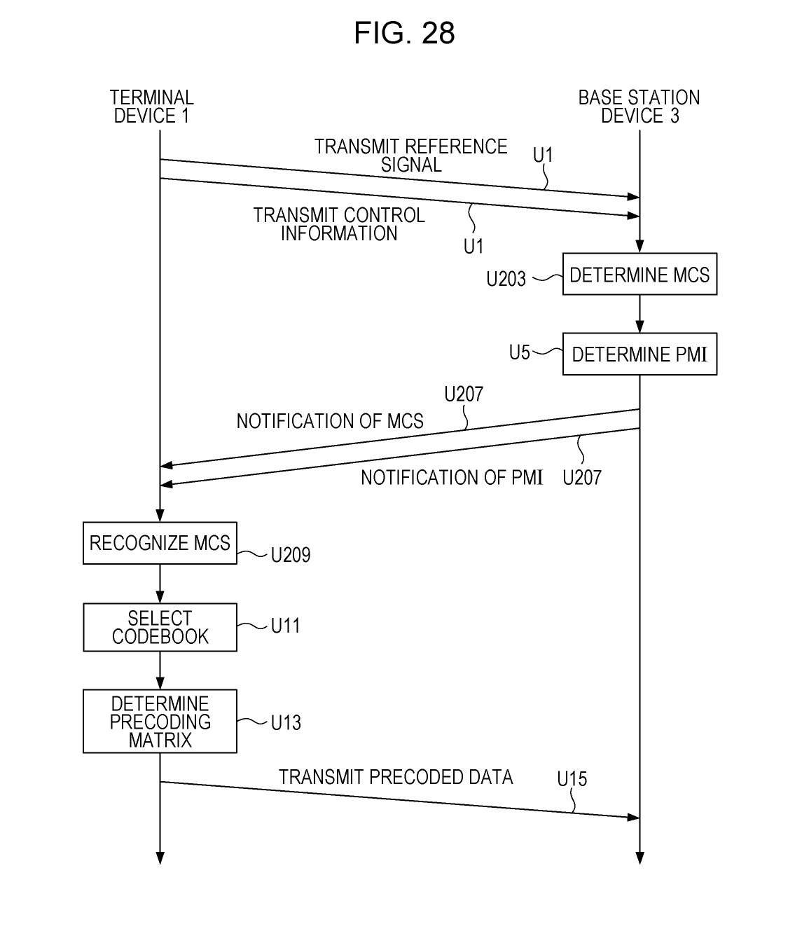

FIG. 28 is a sequence chart illustrating processing performed by the terminal device 1 and the base station device 3 according to the third embodiment of the present invention. First, the terminal device 1 transmits a reference signal and control information to the base station device 3 (step U1), and thereby the base station device 3 determines the MCS to be used for the next uplink transmission (step U203), and determines, with the PMI determination unit 1101 illustrated in FIG. 26, a PMI (step U5). The base station device 3 notifies the terminal device 1 of the MCS information to be used for the next uplink transmission and the PMI that have been determined (step U207). The terminal device 1 recognizes, from the MCS information, the MCS to be used for the next uplink transmission (step U209), and selects a codebook (step U11) and determines a precoding matrix (step U13) by using the precoding matrix determination unit 901 illustrated in FIG. 22. The terminal device 1 multiplies the determined precoding matrix by data, and transmits the data (step U15).

Advantages of this embodiment will be described. In fractional TPC in which transmit power control (TPC) is performed so that the power for reception increases as the terminal device 1 becomes closer to the center of a cell, a signal of the terminal device 1 at the edge of a cell is received with low power, and thus a low-order modulation scheme, such as QPSK, is used for transmission in many cases. In this case, in the PMI determination method according to this embodiment, precoding is performed with a CM being maintained, and thus the transmission performances are not degraded.

On the other hand, a signal of the terminal device 1 at the center of a cell is received with high power, and thus a high-order modulation scheme, such as 64QAM, is used in many cases. In this case, in the PMI determination method according to this embodiment, a precoding matrix for increasing a transmit antenna diversity gain is selected. Thus, compared to the case of performing precoding for maintaining a CM on all the terminal devices 1, the transmission performances can be improved. That is, this embodiment is particularly effective in fractional TPC.

The above-described embodiments can be implemented in combination with one another. For example, according to the present invention, precoding in which a CM is not maintained may be performed in a case where a high-order modulation scheme is used and where the transmission scheme is Clustered DFT-S-OFDM, or precoding in which a CM is not maintained may be performed in a case where a high-order modulation scheme is used or where the transmission scheme is OFDM or Clustered DFT-S-OFDM.

A program that operates in the terminal device 1 and the base station device 3 according to the present invention is a program for controlling a CPU or the like (a program causing a computer to function) so as to implement the functions of the above-described embodiments of the present invention. The information handled in these devices is temporarily stored in a RAM when being processed, and is then stored in a ROM or an HDD, and is read, corrected, or written by the CPU if necessary. As a recording medium that stores the program, any of a semiconductor medium (for example, a ROM, a nonvolatile memory card, etc.), an optical recording medium (for example, a DVD, an MO, an MD, a CD, a BD, etc.), and a magnetic recording medium (for example, a magnetic tape, a flexible disk, etc.) may be used. The functions of the above-described embodiments are implemented by executing the program that has been loaded. In addition, the functions of the present invention may be implemented by performing processing in cooperation with an operating system or another application program or the like, in response to an instruction provided by the program.

To circulate the program in the market, the program may be stored in portable recording media or may be transferred to a server computer connected via a network, such as the Internet. In this case, a storage device of the server computer is included in the present invention. A part of the terminal device 1 and base station device 3 according to the above-described embodiments, or the whole terminal device 1 and base station device 3 may be typically implemented as an LSI, which is an integrated circuit. The individual functional blocks of the terminal device 1 and base station device 3 may be individually mounted on chips, or some or all of the functional blocks may be integrated on a chip. The integrated circuit is not limited to an LSI, but the integrated circuit may be implemented by a dedicated circuit or a multi-purpose processor. The type of the integrated circuit may be any of hybrid and monolithic. Part of the functions may be implemented by hardware, and part of the functions may be implemented by software. In a case where development of the semiconductor technologies produces a technology of an integrated circuit or the like that replaces the LSI, an integrated circuit according to the technology may be used.

The embodiments of the present invention have been described in detail with reference to the drawings. The specific configuration is not limited to these embodiments, and design within the gist of the present invention is also included in the claims. The present invention can be utilized in a mobile communication system in which a mobile phone device serves as a terminal device 1.

### REFERENCE SIGNS LIST

1, 1-1, 1-2 terminal device
3 base station device
101 S/P converter
103, 103-1 to 103-L coding unit
105, 105-1 to 105-L modulator
107, 107-1 to 107-L switching unit
109, 109-1 to 109-L DFT unit
111, 111-1 to 111-L reference signal multiplexer
113 reference signal generator
115 precoding unit
117, 117-1 to 117-Nt spectrum mapping unit
119, 119-1 to 119-Nt OFDM signal generator
121, 121-1 to 121-Nt transmit antenna
123 receive antenna
125 control signal receiver
127 modulation scheme acquisition unit
129 transmission scheme identification unit
131 allocation information acquisition unit
133 precoding matrix determination unit
201 IFFT unit
203 CP insertion unit
205 D/A converter
207 analog processor
251 codebook selector
253 number-of-transmit-antennas notification unit
255 precoding matrix selector
257 PMI acquisition unit
301, 301-1 to 301-Nr receive antenna
303, 303-1 to 303-Nr reference signal demultiplexer
305, 305-1 to 305-Nr OFDM signal receiver
307, 307-1 to 307-Nr spectrum demapping unit
309 MIMO demultiplexer
311, 311-1 to 311-L switching unit
313, 313-1 to 313-L IDFT unit
315, 315-1 to 315-L demodulator
317, 317-1 to 317-L decoding unit
319 P/S converter
321 channel estimator
323 modulation scheme determination unit
325 allocation information determination unit
327 transmission scheme determination unit
   329 PMI determination unit
   331 control information transmitter
   401 analog processor
   403 A/D converter
   405 CP remover
   407 FFT unit
   501 codebook selector
   503 number-of-transmit-antennas notification unit
   505 index selector
   601 precoding matrix determination unit
   651 codebook selector
   701 PMI determination unit
   801 codebook selector
   901 precoding matrix determination unit
   1001 codebook selector
   1101 PMI determination unit
   1201 codebook selector

1. A terminal device that includes a plurality of transmit antennas and that performs precoding on a transmit signal, comprising:
a codebook selector configured to select any one of a plurality of codebooks each including a plurality of precoding matrices, in accordance with the number of the transmit antennas and a transmission parameter other than the number of the transmit antennas; and
a precoding matrix selector configured to select any one precoding matrix from the selected codebook, in accordance with a PMI (Precoding Matrix Indicator).

2. The terminal device according to claim 1, wherein the transmission parameter is a magnitude of a CM (Cubic Metric) of a transmit signal.

3. The terminal device according to claim 1, wherein the transmission parameter is information representing a transmission scheme.

4. The terminal device according to claim 1, wherein the transmission parameter is information representing an allocation pattern of a spectrum.

5. The terminal device according to claim 1, wherein the transmission parameter is information representing a modulation scheme.

6. The terminal device according to claim 1, wherein the codebook selector selects any one of a codebook including a plurality of precoding matrices that maintain a CM (Cubic Metric) of a transmit signal, and a codebook including a plurality of precoding matrices that enable acquisition of a favorable transmit antenna gain.

7. A base station device that performs wireless communication with a terminal device that transmits a precoded signal by using a plurality of transmit antennas, comprising:
a codebook selector configured to select any one of a plurality of codebooks each including a plurality of precoding matrices, in accordance with the number of the transmit antennas of the terminal device and a transmission parameter other than the number of the transmit antennas; and
an index selector configured to select any one precoding matrix from the selected codebook and select an index representing the selected precoding matrix,
wherein information representing the selected index is transmitted to the terminal device.

8. (canceled)

9. An integrated circuit that, by being mounted in a terminal device including a plurality of transmit antennas, causes the terminal device to exhibit a plurality of functions, the integrated circuit causing the terminal device to exhibit a series of functions comprising:
a function of selecting any one of a plurality of codebooks each including a plurality of precoding matrices, in accordance with the number of the transmit antennas and a transmission parameter other than the number of the transmit antennas;
a function of selecting any one precoding matrix from the selected codebook, in accordance with a PMI (Precoding Matrix Indicator); and
a function of performing precoding on a transmit signal by using the selected precoding matrix.
